(19) United States
(12) Patent Application Publication
(10) Pub. No.: US 2025/0134737 A1
(43) Pub. Date: May 1, 2025

(54) AN ATTACHMENT SYSTEM

(71) Applicant: ROGER THOMAS MASCULL and ELIZABETH JOCELYN MASCULL, as Trustees of the RT and EJ MASCULL FAMILY TRUS, Rolleston (NZ)

(72) Inventors: Benjamin Joseph Hunt EAGLE, Rolleston (NZ); Paul James EASTWOOD, Rolleston (NZ); Hugo Max Treherne JAMES, Rolleston (NZ)

(73) Assignee: ROGER THOMAS MASCULL and ELIZABETH JOCELYN MASCULL as Trustees of the RT AND EJ MASCULL FAMILY TRUS, Rolleston (NZ)

(21) Appl. No.: 18/835,463

(22) PCT Filed: Jan. 31, 2023
(86) PCT No.: PCT/IB2023/050815

§ 371 Date: Aug. 2, 2024

(30) Foreign Application Priority Data
Feb. 2, 2022 (AU) 2022900191

(51) Int. Cl. A61G 5/12; A47C 7/38

(52) U.S. Cl. CPC A61G 5/121; A47C 7/383

(57) ABSTRACT

The invention provides a connector for attaching a first part to a second part in a connection joint, the connector comprising a body attachable to the first part and comprising link element extending from the body, wherein the link comprises substantially opposing surfaces, each surface comprising a curved region configured to nest with a complimentary curved region of a washer of the connection joint, and further comprising an opening located substantially centrally within each curved region of the arm and passing through the arm.

### CROSS-REFERENCE TO RELATED APPLICATIONS

This application is a National Stage Application of PCT/IB2023/050815, filed Jan. 31, 2023, which claims the benefit of Application No. 2022900191, filed Feb. 2, 2022 in Australia, and which applications are incorporated herein by reference. To the extent appropriate, a claim of priority is made to each of the above disclosed applications.

### FIELD OF INVENTION

This invention relates to an attachment system for adjustably attaching one part to another so that the position of at least one of the parts is adjustable relative to the other. For example, the attachment system may be used for adjustably attaching a headrest to a backrest of a chair, such as a wheelchair, or for adjustably attaching a body support, such as a lateral support or a hip support, to the backrest, seat base, or frame of a chair, such as a wheelchair.

### BACKGROUND

A wheelchair typically comprises a frame that supports a seat base, on which an occupant of the wheelchair sits during use. The frame includes canes/posts, which are attachable to a backrest/seat back. The wheelchair frame also attaches to and supports wheels or castors. For wheelchair users that require head support, a headrest is often provided with the wheelchair. The headrest may be part of the backrest, but more commonly, the headrest is detachably attachable to the backrest and is adjustable in position to suit the occupant of the wheelchair.

To provide adjustability of the position of the headrest (such as its height and orientation), one known attachment system comprises at least one ball joint that is located between the headrest and the backrest. Often, the attachment system comprises a series of elongate members or rods that are attached together by two or more ball joints and that attach to the headrest at one end and to the backrest at the other end. This form of attachment system is typically intricate and includes many moving and inter-connected parts, making the system difficult and expensive to manufacture. The resulting system also includes the weight of each of its parts and can therefore be heavy. Each ball joint in the system also comprises multiple fasteners, which are necessary to secure the position of the ball joint. Each fastener has to be tightened or loosened by hand to lock or release the position of the ball joint. Therefore, the attachment system is time consuming for a user to adjust.

Another known attachment system comprises a series of elongate members that are connected together by multiple hinged joints and that attach to the headrest at one end and to the backrest at the other end. Each hinged joint is configured to hinge around a different axis to that of an adjacent hinged joint. Because each hinge allows adjustment around just one axis, multiple hinges are required to allow the headrest to adopt different orientations and heights. Some such systems only use two hinges, and only offer very limited adjustment of the position of the headrest. Other such systems may use six or more hinged joints, which therefore require the attachment system to include many components, adding to the cost of manufacture and the weight of the system. Each hinged joint needs to be secured independently to lock the position of the headrest, so it is difficult, and time consuming for a user to lock and unlock the position of the headrest. Consequently, many iterations may be required to adjust the position of the headrest in order to reach the desired position that is most suitable for the individual needs of the occupant of the chair.

It would therefore be useful to provide an attachment system that may be used for attaching one part to another and that goes at least some way towards overcoming the disadvantages of the prior art, or that at least provides the public with a useful alternative.

### SUMMARY OF INVENTION

In a first aspect, the invention provides a connection joint for attaching a first part to a second part, the joint comprising: at least one support member; at least one connection member; at least one first washer/spacer between the support member and the connection member; an attachment shaft that extends through openings in the support member, connection member, and washer(s) such that the support member, connection member and washer(s) form an arrangement of components; wherein the attachment shaft defines a first axis substantially centrally located along its length and the support member, connection member and washer(s) are rotatable about the first axis; wherein the at least one first washer comprises a curved region that slidably and rotatably nests with a complimentary curved region of the at least one support member, the at least one connection member, or of a second, adjacent washer/spacer; wherein the connection member or the support member or both, and at least one adjacent washer located between the support member and the connection member, comprises an enlarged opening comprising a width or diameter greater than a diameter of the attachment shaft to allow the connection member or the support member or both to rotate about a second axis and a third axis to adopt various positions relative to the other, the second and third axes being perpendicular to the attachment shaft and to each other; and wherein the joint further comprises a clamping system to clamp the elements of the joint together in a locked position, and to unclamp the elements in an unlocked position in which the connection member or the support member is moveable about the first, second and third axes.

In some forms, the support member comprises a pair of arms and the connection member is located between the arms, and a pair of washers is located between each arm of the support member and the connection member, each washer pair comprising a first washer comprising a concave curved region and a second washer comprising a convex curved region for being slidably and rotatably received within the concave region of the first washer.

In some forms, the opening of each of the first and second washers is substantially centrally located on the washer, and the openings of the first washers or the second washers comprise a diameter larger than a diameter of the attachment shaft.

In some forms, the attachment shaft comprises a bolt comprising a nut located at or near the distal end of the shaft, the nut being moveable toward and away from a head of the bolt to move between a clamped and unclamped position respectively, the nut and both together defining the clamping system.

In some forms, the joint further comprises a pair of anti-rotation caps, each cap being located proximate to a distal end of the attachment shaft and comprising a recess for receiving the bolt head or nut therein.

Optionally, each anti-rotation cap comprises an engagement member for engaging with the support member.

In some forms, the engagement member comprises a projection and the support member comprises a notch for receiving the projection therein.

In some forms, the connection member comprises a link comprising a first linkage attached to the attachment shaft, and a second linkage slidably attached to the first linkage.

Optionally, the first and second linkages are curved about a common point to form an arc.

In some forms, the support member attaches to a lateral support and the connection member attaches to a chair.

In a second aspect, the invention provides a connector for attaching a first part to a second part in a connection joint comprising one or more curved washers and an attachment shaft, the connector comprising a body, comprising an attachment feature to attach to the first part, and a link element extending from the body, wherein the link element comprises a pair of substantially opposing surfaces, each surface comprising a curved region adapted to nest with a complimentary curved region of one curved washer of the connection joint, and further comprising an opening located substantially centrally within each curved region of the link element from one of the substantially opposing surfaces to the other, the opening being adapted to receive the attachment shaft for attaching the second part to the connector.

In some forms, the curved region is a concave region or a convex region.

In some forms, the link element comprises a substantially planar projection that projects substantially centrally from the connector body, and wherein the curved regions are located on opposing sides of the planar projection.

In some forms, the attachment feature of the connector body comprises an attachment surface comprising a recess for engaging with a projection of a mounting plate, or for receiving a fastener therein to attach the connector to a mounting plate, or for receiving one end of a rod therein.

In a third aspect, the invention provides a connection joint for attaching a first part to a second part, the joint comprising: a first support member comprising a first connector according to the invention, a pair of connection members, a pair of washers, each washer being located between the support member and one of the connection members, and each washer comprising a curved region for slidably and rotatably nesting with the curved region of the first support member; a first attachment shaft extending through openings of the first support member, the connection members and the washers, the attachment shaft comprising defining a first axis centrally located along its length, wherein the support member, connection member and washers are rotatable about the first axis, wherein the connection member, or the washers, or both, comprises an enlarged opening comprising a diameter greater than a diameter of the attachment shaft allow the connection member, washers, or both, to rotate about a second axis and a third axis to allow the connection member to adopt various positions relative to the support member, the second and third axes being perpendicular to the attachment shaft and to each other; and a clamping system that clamps together the first connector, the connection members and the washers in a locked position, and that releases the first support member, the connection members and the washers in an unlocked position so that the position of at least the connection members is adjustable relative to the support member.

In a fourth aspect, the invention provides a connection system comprising the connection joint of the first aspect of the invention and wherein each connection member comprises a link comprising a first opening located

near a first end of the link and through which the first attachment shaft extends, and a second opening located near a second end of the link, wherein a second support member comprising a second connector according to any one of claims 11 to 14 is located between each connection member and wherein a second washer comprising a curved region for slidably and rotatably nesting with a respective curved region of the second support member is located between the second end of each connection member and the second support member, the system further comprising: a second attachment shaft that extends through openings in the second end of each connection member, the second washers, and the second support member; and a second clamping system that clamps together the second support member, the connection members and the second washers in a locked position, and that releases the second connector, the connection members and the second washers in an unlocked position so that the position of at least the connection members is adjustable relative to the second support member.

In some forms, each of the washers comprises a convex curved region that is slidably and rotatably received within a concave curved region of the respective first or second connector.

In some forms, the first support member is attached to a head support of a chair via a mounting member/plate.

In some forms, the second support member is attached to a backrest of a chair via an adjustment element/rod.

In a fifth aspect, the invention provides a connection joint to adjustably attach a first part to a second part, wherein the joint comprises: a first washer pair and a second washer pair, wherein each pair comprises a first washer comprising a substantially curved region and a second washer comprising a complimentary curved region, such that each washer in a washer pair slidably and rotatably nests with the other washer in the same washer pair, and wherein the first part is adjacent at least one of the first and second washer pairs and the second part is located between the first and second washer pairs; an attachment shaft comprising a length that extends through openings provided in the first and second washers of each washer pair and through the first and second components, wherein the attachment shaft is snugly received within the opening of the first part and each first washer and wherein the openings of the second washers and the second part have a diameter sufficiently larger than the diameter of the attachment shaft to allow the second washers and the second part to tilt relative to the attachment shaft or the support member and to slide in a direction substantially perpendicular to the length of the attachment shaft; and a clamping system to clamp the elements of the joint together in a locked position, and to unclamp the elements in an unlocked position in which the connection member is moveable about the first, second and third axes.

In some forms, the clamping system comprises a clamping member that is moveable along the attachment shaft in a first direction to clamp the first and second washer pairs and the first and second components together in a locked position, and is moveable along the attachment shaft in a second direction, substantially opposite the first direction, to release the washer pairs and first and second components to allow the position of the first component or the second component to be adjusted relative to the other.

In some forms, the curved region of the first washer is a convex region and the curved region of the second washer is a concave region.

Optionally, the curved region of the first washer is a concave region and the curved region of the second washer is a convex region.

In some forms, the first part comprises a mounting plate for attaching to a head support or lateral support of a chair, such as a wheelchair.

In some forms, the second part comprises a brace for attaching a head support or lateral support to a chair, such as a wheelchair.

In some forms, the first component comprises a pair of arms, each arm being located on one side of the first and second washer pairs, and wherein the second component comprises a linking member located between the first and second washer pairs.

Optionally, a distal end of the attachment shaft, or a clamping member, or both are received within a respective cap that prevents inadvertent rotation and release of the clamping member.

In some forms, each cap comprises an engagement element that engages with an engagement feature of the linking member.

Optionally, the connector comprises four pairs of washers, wherein the first component comprises three arms, one arm being located on an outer side of the outermost washer pairs, and one arm being located between the innermost washer pairs, and wherein the second component comprises a pair of arms, each arm of the second component being located between a respective one of the outermost washer pairs and one of the innermost washer pairs.

In a sixth aspect, the invention provides a connection joint for attaching a first part to a second part, the joint comprising: a support member, a connection member and at least one washer between the support member and the connection member, wherein each of the support member, the connection member and the at least one washer comprises an opening; wherein the connection joint also comprises an attachment shaft that passes through the openings of the support member, the connection member and the at least one washer; wherein the connection member comprises a curved region and the at least washer comprises a complimentary curved region such that the curved region of the washer nests within the curved region of the connection member, and wherein the openings of the washer and the connection joint are larger than a diameter of the attachment shaft to provide a sloppy fit between the washer and the connection member, and the attachment shaft, such that one of the connection member and the support member can pivot about a second axis and a third axis, the second and third axes being substantially perpendicular to the first axis and to each other.

In a seventh aspect, the invention provides a connection joint for attaching a first part to a second part, the joint comprising a support member, a connection member, and a pair of washers located between the support member and the connection member wherein one of the washers comprises a concave surface and the other of the washers comprises a convex surface such that the concave and convex surfaces allow the washers to nest together, wherein an attachment shaft passes through openings provided in the support member, the connection member and the washers and defines a first axis about which the support member, the connection member and the washers can rotate, and wherein the opening of at least one of the washers and of one of the connection member and the support member is larger than a diameter of the attachment shaft to provide a sloppy fit between the washer and the connection member or support member, and the shaft, such that one of the connection member and the support member can pivot about a second axis and a third axis, the second and third axes being substantially perpendicular to the first axis and to each other.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this specification is not, and should not be taken as, an acknowledgement or any form of suggestion that that prior art forms part of the common general knowledge in the field of endeavour in any country in the world.

The invention consists in the foregoing and also envisages constructions of which the following gives examples only.

### BRIEF DESCRIPTION OF THE DRAWINGS

Preferred forms of the invention will now be described by way of example and with reference to the accompanying drawings, in which:

FIGS. 1 and 1a are isometric rear and front views respectively, showing an exemplary wheelchair comprising a head rest and a lateral support attached to the chair using some forms of connectors and connection joints of the invention;

FIGS. 1b and 1c are isometric rear and front views of the wheelchair in FIGS. 1 and 1a, and in which the headrest and lateral support have been manipulated to different positions using the connection joints of the invention;

FIG. 2 is a rear isometric view of one form of headrest showing one form of connection joint of the invention that allows the position of each pad of the headrest to be adjustable relative to a support plate of the headrest;

FIG. 2a is a rear exploded view of one of the pads of the headrest of FIG. 2 and part of the support plate, showing one form of connection joint of the invention, the connection joint forming a stacked washer arrangement;

FIG. 3 is a top view of the headrest support plate of FIG. 2, without the headrest pads attached, and showing the stacked washer connection joint of FIG. 2a attached to each side of the support plate;

FIG. 3a is a cross-sectional view taken along line A-A of FIG. 3 and showing the stacked washer arrangement of the connection joint;

FIG. 3b is an enlarged view of a portion of the cross-section shown in FIG. 3a when the connection joint is in a neutral position in which the first and second elements of the joint are substantially perpendicular to the attachment shaft of the joint and substantially parallel to each other;

FIG. 3c is another enlarged view of a portion of the cross-section shown in FIG. 3a when the second element has been tilted relative to the first element by slidably rotating at least one washer in each washer pair relative to the other washer in the washer pair, the movable washer pressing against the second element to urge the second element to another position;

FIG. 3d shows the headrest of FIG. 2 attached to an adjustable bracket, comprising a first element in the form of a headrest plate (the Figure illustrates a portion of the plate only), and two pairs of nesting washers, for attaching the headrest to a chair, such as a wheelchair;

FIG. 4 shows one form of connection joint that is similar to that of FIGS. 2 and 2a, but in which an arcuate region surrounds the opening on one side of the first element and in which an adjacent arcuate washer nests with the arcuate region;

FIG. 5 shows a lateral support attached to an adjustable bracket using another form of connection joint according to the invention;

FIG. 5a is an exploded view of the connection joint shown in FIG. 5;

FIG. 5b is a side view of the lateral support, adjustable bracket, and connection joint of FIG. 5;

FIG. 5c is a cross-sectional view of one form of connection joint, as used in FIG. 5, showing the connection joint in a neutral position in which the first and second elements are in a neutral position, in which each of the first and second elements is substantially perpendicular to the attachment shaft and to each other;

FIG. 5d is another cross-sectional view of the connection joint of FIG. 5c and in which the joint is in a modified position, in which the second element has been tilted relative to the first element so as to be non-perpendicular with the attachment shaft by slidably rotating at least one washer in each washer pair relative to the other washer in the washer pair, to press against and tilt the second element;

FIG. 6 shows the lateral support and connection joint of FIG. 5 in a different position, in which the connection joint is configured so that the first element is tilted relative to the second element so as to be non-perpendicular with the attachment shaft, allowing the angle of the lateral support to be adjusted relative to the slidable bracket and therefore relative to the backrest of the chair to which the support is or will be attached;

FIG. 7 is one form of connector according to the invention, the connector being useable with a connection joint of the invention and being configured to attach to a rod/shaft;

FIG. 7a is an end view of the base of the connector of FIG. 7, in which the attachment surface of the connector base can be seen;

FIG. 8 is another form of connector according to the invention, the connector comprising a concave region to engage with a convex region of another component of a connection joint, such as a washer comprising a convex nesting surface, and comprising an attachment feature configured to attach to a mounting feature, such as a mounting plate;

FIG. 8a shows an end view of the base of the connector of FIG. 8, in which the attachment surface of the connector base can be seen;

FIG. 8b is another form of connector according to the invention, the connector comprising a convex region to engage with a concave region of another component of a connection joint, such as a washer comprising a concave nesting surface, and comprising an attachment feature configured to attach to a mounting feature, such as a mounting plate;

FIG. 9 is an isometric view showing a first connector of the invention forming part of a first connection joint attached to a mounting plate, a second connector forming part of a second connection joint attached to a shaft/rod, and a pair of connection members attached to both connectors to form an attachment system of the invention;

FIG. 9a is an exploded view of the connectors, connection joints and attachment system of FIG. 9;

FIG. 9b is an exploded view of an alternative connection joint and attachment system of FIG. 9;

FIG. 10 is an isometric view showing the attachment system of FIG. 9 and in which axis A can be seen passing through the first connection joint and axis B can be seen passing through the second connection joint;

FIG. 10a is an annotated view of FIG. 10, showing the different axes about which, the connection members can rotate, axis X₁ being equivalent to axis A of FIG. 10 and axis X₂ being equivalent to axis B of FIG. 10;

FIG. 11 is a rear view of the attachment system of FIG. 10 in a neutral position and showing both first and second connection joints in a neutral position;

FIG. 11a is a cross-sectional view of either one of the connection joints of FIG. 11 in the neutral position in which the connection members and the connector (located intermediate the connection members) are substantially perpendicular to the attachment shaft and to each other;

FIG. 11b is a cross-sectional view of the connection joint of FIG. 11a, but in a modified position in which the connector is tilted relative to the attachment shaft and as illustrated in FIG. 12;

FIG. 12 shows the attachment system of FIG. 11, but in a modified position in which the connection members of the first and second connection joints are tilted by 10 degrees relative to vertical;

FIG. 12a also shows the attachment system of FIG. 11, but in a modified position in which the connection members of the first and second connection joints are tilted by 10 degrees relative to vertical and the connector of the first connection joint is tilted by 20 degrees relative to vertical;

FIG. 13 is an exploded view of another form of attachment system, similar to that shown in FIG. 9b, but in which the connection members comprise concave curved regions for nesting with adjacent washers; and

FIG. 14 is an exploded view of another form of attachment system, similar to that shown in FIG. 13, but in which the connection members comprise convex curved regions for nesting with adjacent washers.

### DETAILED DESCRIPTION

The invention is further described with reference to the following examples. It will be appreciated that the invention as claimed is not intended to be limited in any way by these examples.

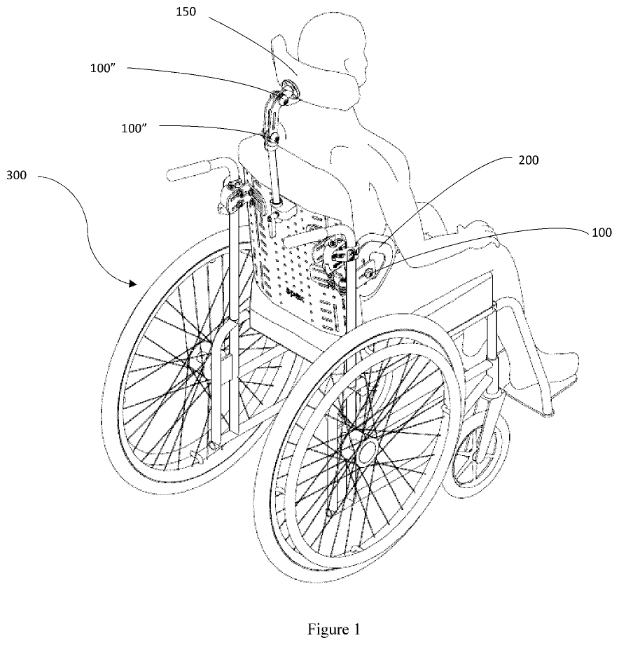

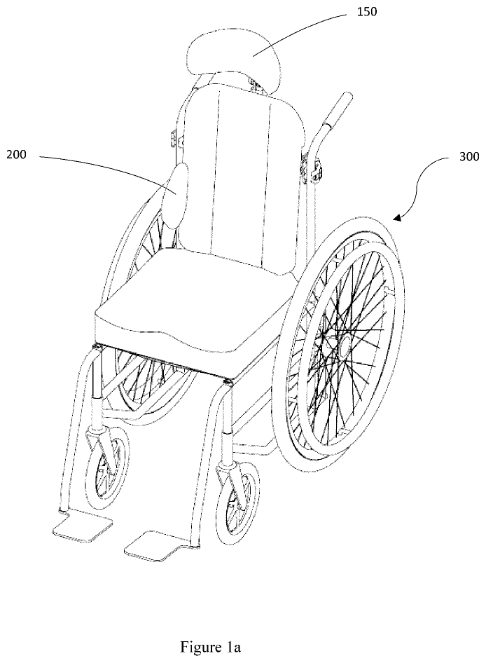

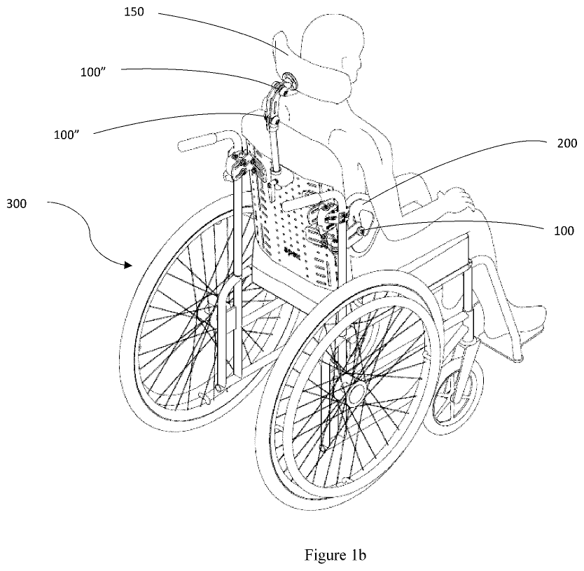

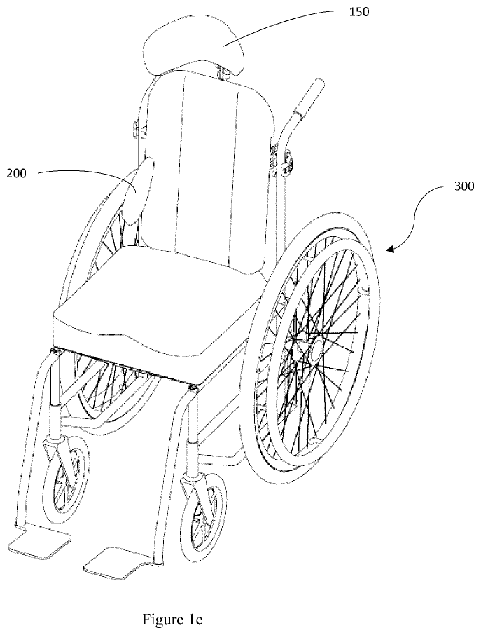

As exemplified by embodiments shown in FIGS. 1 to 14, the present invention relates to a connection joint that attaches a first part to a second part and comprises an arrangement of components connected together by an attachment shaft. One of the components may be attached to or integral with the first part and another of the components may be attached to or integral with the second part. At least two adjacent components comprise complimentary curved nesting features such that at least one of the nesting components is rotatably slidable relative to the other nesting component, so that at least one or both of the first and second parts can be tilted/angled and rotated relative to the attachment shaft for position adjustment.

In some forms, the connection joint may be used to attach a movable headrest to a backrest of a chair, such as a wheelchair. Or the connection joint may be used to attach a moveable lateral support (for supporting the torso of a physically disabled person) to a chair, or to attach a hip support to a chair, such as a wheelchair. When two connection joints of the invention are attached to first and second parts and to each other, at least one of those parts may be manipulated to be tilted/angled, transposed, and/or rotated relative to the other part.

The connection joint may take many different forms, but in each form, the connection joint comprises at least one first element/support member/connector, at least one second element/connection member and at least one washer/spacer or a pair of washers/spacers located between the first element and the second element. The first element(s), second element(s), and washer(s) form components of the connection joint and may be located along the attachment shaft in various different configurations. In each form, the connection joint is configured so that at least one of the components comprises a curved/semi-spherical nesting feature for nesting with a curved/semi-spherical nesting feature of an adjacent ‘curved’ washer. A curved washer, in this specification is considered to be one that comprises a peripheral edge (typically a circumferential edge) and two opposing side surfaces facing away from each other. At least one of the side surfaces comprises a curved/semi-spherical region/seat to nest with a curved/semi-spherical region/seat of an adjacent curved washer or (in some embodiments) a curved/semi-spherical region of another component of the connection joint. Such curved washers are often referred to as ‘spherical washers’ in trade.

The first element, the second element, and the washers each comprise an opening, such as a substantially circular hole/bore or a slot, that extends through the respective element, from one side of the element to the other side, for receiving the attachment shaft therein. The attachment shaft extends through the substantially aligned openings of the first element, the second element, and washers so that these components are arranged along a portion of the shaft length. However, the arrangement of these components may vary between different embodiments of the invention.

The attachment shaft defines a first axis centrally located along the length of the shaft. The first element, the second element, and the washer(s) are rotatable about the first axis.

At least one of the first element and the second element is configured to be manipulated at an angle to the other or to the attachment shaft and/or to be rotated relative to the other, which movement is facilitated by the configuration of the curved washer(s), including the size of the openings of the washer(s), and the size of the openings provided in the first element and/or second element relative to the diameter of the attachment shaft.

For example, in some forms, the nesting feature of a curved washer may comprise a curved semi-spherical concave or convex/conical region on at least one side of the washer for nesting with a complimentary nesting feature comprising a curved semi-spherical convex/conical or concave region of an adjacent washer. In such forms, at least one of the adjacent nesting curved washers can slide and rotate relative to the other. In other forms, at least one of the curved washers comprises a nesting feature comprising a curved semi-spherical concave or convex region on at least one side of the washer for nesting with a nesting feature of the first element or second element, adjacent the nesting washer, such that the first element or second element (as the case may be) is slidable and rotatable relative to the other of the first and second elements.

In some forms, at least one curved washer is located adjacent to the first or second element and comprises an enlarged opening comprising a diameter or width sufficiently larger than the diameter of the attachment shaft to allow the washer to rotate about three axes, the axes being perpendicular to each other.

The ability of the curved/arcuate washer(s) to rotate about the first, second and third axes allows the washer(s) to manipulate the first and/or second elements to adopt various angled/tilted positions relative to the attachment shaft.

In some forms, the first or second element comprises a curved nesting region and an enlarged opening and an adjacent washer comprises a curved nesting region and an enlarged opening comprising a diameter or width sufficiently larger than the diameter of the attachment shaft to allow the first or second element (as the case may be) to rotate about the first, second and third axes.

The connection joint may be configured so that the first element attaches to or is integral with a first part and the second element attaches to or is integral with a second part. The washers are configured to allow the first and/or second elements to swivel/tilt/angle relative to the other and/or the attachment shaft, thereby allowing one or both of the first and second parts to be transposed, angled and/or rotated relative to the other. Optionally, the first and second parts are components of a chair or components of accessories to a chair.

The connection joint may also comprise a clamping system to clamp/lock the components of the joint together in a locked position, and to unclamp/unlock the components in an unlocked position in which at least one of the first and second element is moveable about first, second, and third axes to provide six degrees of freedom.

The connection joint of the invention is moveable between a neutral position, in which the first and second elements are substantially perpendicular to the attachment shaft, and a modified position in which the first or second elements, or both, are tiltable and rotatable relative to the attachment shaft.

FIGS. 1 and 1a show a wheelchair 300 comprising a headrest 150 and a lateral support 200, both of which are attached to the wheelchair using different forms of connection joint 100, 100″ of the invention. FIGS. 1b and 1c show the same wheelchair in which the headrest and lateral support have been moved to a different position by adjustment of the respective connection joints 100, 100″.

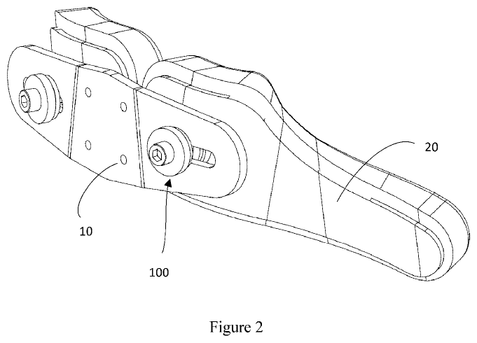

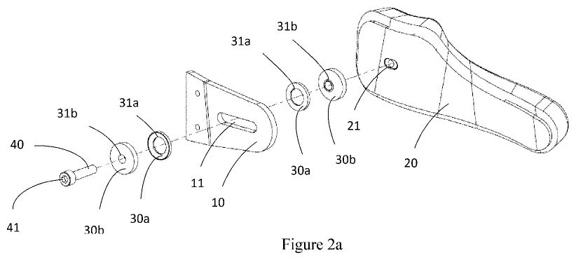

FIGS. 2 to 4 illustrate a headrest support plate attached to an adjustable headrest pad by one form of connection joint 100 of the invention. In this embodiment, the first element/support member 10 is integral with the first part and the second element/connection member 20 is integral with the second part. For example, the connection joint 100 comprises a first element 10 comprising the headrest plate, a second element 20 comprising the headrest pad, and a pair of curved, nesting washers/spacers 30a, 30b located on either side of the first element 10. In some forms, as shown best in FIG. 2a, at least one pair of nesting washers 30a, 30b is located between the first and second elements 10, 20 and at least one pair of nesting washers 30a, 30b is located between one clamping member (such as a bolt head 41, as shown in FIG. 2a, or a nut) and the first element 10.

Each nesting washer 30a, 30b comprises a peripheral edge and two opposing side surfaces. A nesting feature comprising a semi-spherical curved region is provided on at least one side surface of each washer 30a, 30b. The curved regions of each washer in a washer pair 30a, 30b are complimentary so as to nest with each other. For example, a first nesting washer 30a in a washer pair may comprise a concave, semi-spherical curved region and the second nesting washer 30b in the washer pair may comprise a convex, semi-spherical curved region.

In each washer pair, the first nesting washer will be referred to herein as a convex washer because one side of the first washer comprises a semi-spherical convex/outwardly curved region. The second nesting washer will be referred to herein as a concave washer because one side of the second washer has a semi-spherical concave/inwardly curved region that is shaped and dimensioned to receive at least a portion of the convex region of the convex washer therein.

Each nesting washer 30a, 30b comprises an opening 31a, 31b for receiving an attachment shaft therein.

An attachment shaft 40, comprising a bolt, rod, or the like, extends through openings 11, 21, 31a, 31b provided in each of the first and second elements 10, 20, and the paired nesting washers 30a, 30b. The attachment shaft comprises a pair of clamping members 41, 42 to clamp the components of the connection joint firmly together in order to clamp/lock the connection joint in position.

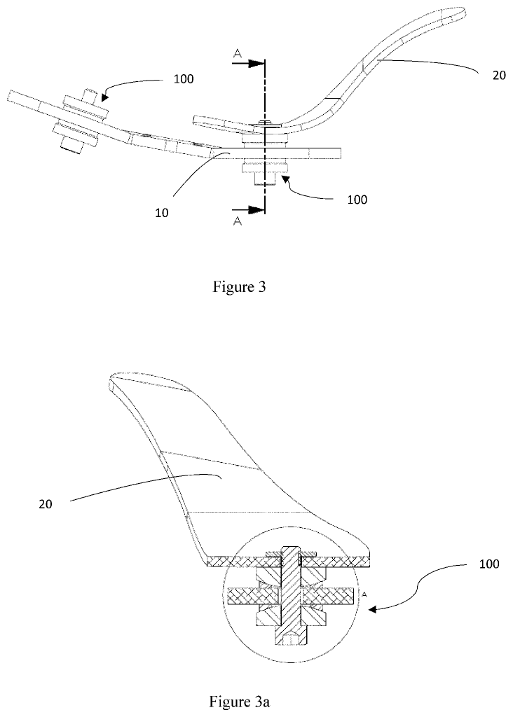

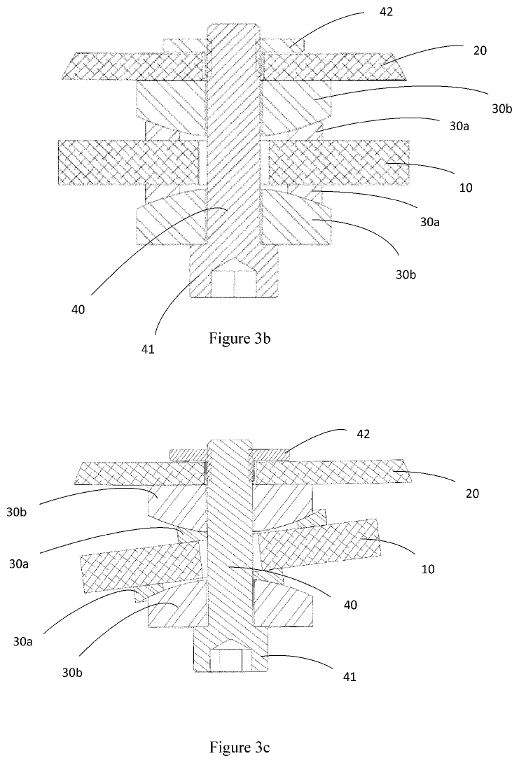

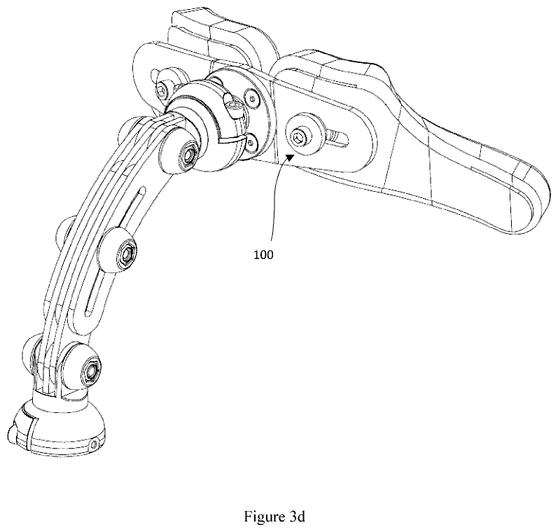

The attachment shaft 40 defines a first axis A-A that extends longitudinally and substantially centrally along the length of the attachment shaft, as shown in FIG. 3. The first and second elements 10, 20, and each pair of nesting washers 30a, 30b are configured to rotate about the attachment shaft 40 and therefore about the first axis in an unclamped position.

In a neutral position, the first and second elements 10, 20 are arranged to be substantially perpendicular to the attachment shaft 40. However, the connection joint 100 may be configured to allow at least one of the first and second elements 10, 20 to also be rotatable about second and third axes to adopt a modified position, the second and third axes being substantially perpendicular to the attachment shaft 40 and to each other.

For example, the first and second elements 10, 20 may comprise openings 11, 21 for receiving the attachment shaft 40 therein, and which may be of any suitable form, such as a slot opening or a substantially circular hole/bore. The openings 11, 21 of at least one of the first and second elements 10, 20, or both, may comprise a width (if the opening is a slot) or a diameter (if the opening is a substantially circular hole/bore) that is larger than that of the attachment shaft 40 to form a sloppy fit. For example, in the embodiment illustrated in FIG. 2a, the first element 10 comprises an enlarged opening 11 in the form of a slot having a width greater than the diameter of the cylindrical attachment shaft 40. The second element 20 comprises an opening in the form of a substantially circular bore 21 that forms a substantially snug fit with the attachment shaft 40, but is preferably slidable along the shaft.

The convex and concave washers may nest together and are configured so that, when the connection joint is not clamped in position, at least one of the washers, or both of the washers, is/are rotatable about the first axis (defined by the longitudinal axis of the attachment shaft) and is/are also rotatable about second and third axes by arcuately sliding the convex region of the first nesting washer within the concave region of the second nesting washer. The diameter of the opening of the sliding washer determines the maximum distance at which the washer can slide in one direction.

In some forms, at least one of the nested concave 30a and convex 30b washers may comprise an enlarged opening 31a, 31b, such as an enlarged substantially circular hole/bore 31a having a greater diameter than that of the attachment shaft 40. In the embodiment shown in FIGS. 2a, 3a, and 3b the concave washers 30a each have an enlarged bore 31a. Therefore, both the first element 10 and the concave washers 30a are configured to provide a sloppy fit with the shaft 40 to allow rotational movement of the washer about all three axes. The opening 31a, 31b of the other of the curved washers (the convex washers in the embodiment illustrated in FIGS. 2a, 3a, and 3b) in each washer pair 30a, 30b and the opening 21 of the second element 20 may have a diameter only slightly larger than that of the attachment shaft 40 to snugly receive the attachment shaft 40 within each opening 31a, 31b, 21 and to preferably be able to rotate about the first axis and slide along the shaft. This arrangement allows the concave washers with an enlarged opening to slide and rotate (move arcuately) within the curved region of the nesting convex washers, thereby pressing against and tilting the first element 10 relative to the second element 20. In alternative forms, the second element 20 and the convex washers 30b may comprise enlarged openings 21, 31b, whereas the first element 10 and concave washers may comprise openings that snugly and slidably receive the attachment shaft therein, such that the second element 20 is tiltable relative to the first element 10. Of course, both washers may also have an enlarged opening/bore, but depending on the use of the connection joint 100, such an arrangement may produce too much slop and not enough rigidity in the joint to enable the joint to be easily manipulated and held in a desired position.

In the embodiment shown in FIG. 2a, the attachment shaft 40 comprises a bolt comprising a threaded portion. A pair of clamping members 41, 42, are provided on the shaft, one clamping member being located at or near each end of the shaft 40.

In some forms, at least one or both of the clamping members 41, 42 may be movable along the length of the shaft 40 to move between a clamped position and an unclamped position.

In some forms, as shown in FIGS. 2 to 3a, a bolt head 41 forms one of the clamping members and is fixedly located at one end of the shaft/bolt 40. A removable fastener 42, such as a nut or T-nut, is attached to the other end of the shaft and forms the other clamping member. The removable fastener is moveable along the length of the shaft 40 to attach the second element 20 to the first element 10. The nut 42 comprises a threaded interior hollow that engages with the threaded portion of the shaft 40 to allow the nut to be moved along the length of the shaft 40 to adopt a clamped and an unclamped position.

In other forms, the attachment shaft 40 may comprise a rod comprising a threaded portion and having a removable fastener, such as a nut, attached at or near each end of the shaft, each nut forming a clamping member. In this arrangement, both nuts comprise a threaded interior hollow to engage with the threaded portion of the shaft so that the nuts are moveable along the length of the attachment shaft to adopt a clamped position and an unclamped position.

In some forms, the opening 21 of the first and/or second elements 10, 20 may be threaded to engage with a threaded portion of the shaft 40 to allow the first and/or second elements 10, 20 to act as a clamping member and to press against other components of the joint when in the clamped position.

To reach the clamped position, in some forms, at least one of the clamping members 41, 42 moves toward the arrangement of components located on the shaft and between the clamping members (first and second elements 10, 20 and nested washers 30) until the clamping member abuts the outermost component and pushes the components along the shaft 40 toward the other clamping member until the first and second elements 10, 20, and washers 30 are clamped against each other and between the clamping members 41, 42. For example, where the clamping members comprise at least one nut, rotating the nut 42 in a first direction, so as to move along the shaft 40 toward the other end of the shaft, causes the nut to press against the components 10, 20, 30a, 30b located between the clamping members 41, 42. Alternatively, the attachment shaft 40 may comprises a threaded portion and may be rotated in a first direction to cause the nut 42 to move along the shaft 40 toward the other end of the shaft. As the components 10, 20, 30a, 30b are pressed between the clamping members, the first and second elements 10, 20 and washers 30a, 30b are clamped together in a clamped/locked position.

In the clamped/locked position, the first and second elements 10, 20 and washers 30a, 30b are unable to move relative to each other, therefore locking the position of the first part relative to the second part. Where the connection joint 100 is used to attach a headrest to a wheelchair backrest, the connection joint 100 will lock the headrest in position relative to the backrest when in the clamped/locked position. Similarly, where the connection joint 100 is used to attach a headrest pad to a headrest plate, the connection joint 100 will lock the pad in position relative to the headrest plate, when the joint 100 is in the clamped/locked position. FIG. 3d shows one form of connection joint 100, used to attach a headrest to a headrest plate, and in which the join is in the clamped/locked position to prevent the headrest from moving relative to the plate.

To reach the unclamped position, at least one of the clamping members 41, 42 is caused to move away from the components of the joint 10, 20, 30a, 30b, such as by moving away from the other end of the shaft 40, to release the clamping pressure against the components 10, 20, 30a, 30b and adopt an unclamped/unlocked position. For example, by rotating at least one removable fastener/nut 42 or by rotating the attachment shaft 40 (where the attachment shaft comprises a threaded portion) in a second direction (opposite to the first direction), so as to move the nut 42 along the shaft 40 in a direction away from the other end of the shaft, the nut 42 may be caused to release the clamping pressure on the components 10, 20, 30a, 30b located between the clamping members 41, 42, allowing the components to rotate about the shaft 40.

In the unclamped position, at least the first and second elements 10, 20, or both, can tilt relative to the attachment shaft to allow the position of the first part and/or the second part to be adjusted. The arcuately slidable washers within each washer pair are typically located adjacent the tiltable first or second element to provide space in which the first or second element can tilt relative to the attachment shaft.

In some forms, the first element 10 may be attachable to, or integral with, a first part comprising a headrest plate, a backrest, a frame, seat base, arm rest, or other structural component of a chair, such as a wheelchair. In some forms, the second element 20 may be attachable to, or integral with, a second part that requires that its position is adjustable relative to the first element 10. For example, the second part may be a head rest pad, a head support (which may include a headrest plate and a headrest pad, for example), or a lateral support (such as a torso support or a hip support). The first part (which may be one of the first and second elements) may remain in a fixed position and the second part (which may be the other of the first and second elements) may be moveable relative to the first part, or both the first and second parts may be moveable relative to each other, especially where the first and second parts form part of an articulated arrangement comprising at least three connection joints, such as where connection joints of the invention are used to attach a rear head support to a backrest and to a forehead support.

The connection joint of the invention may be provided in different configurations 100, 100′, 100″ in which the number and/or configuration of components of the joint that are arranged on the shaft 40 (such as first and second elements, and washers/spacers) may vary from those exemplified in relation to FIGS. 2 to 3d.

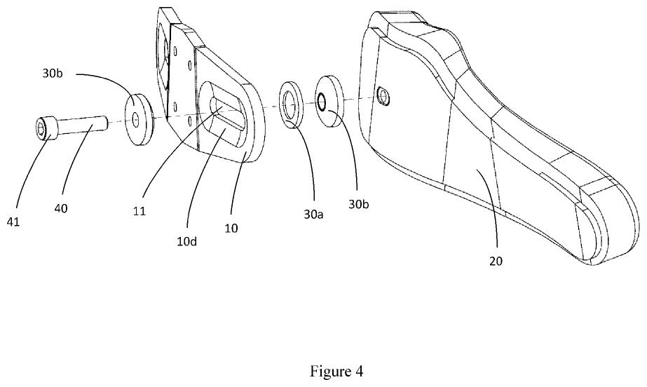

For example, FIG. 4 shows a headrest arrangement that includes substantially the same features as that shown in FIGS. 2 and 2a, but in which the first element 10 (in this case the headrest plate) comprises an arcuate region 10d surrounding the opening 11 and being configured to nest with an adjacent washer 30b. In such an arrangement, a single arcuate washer may slide and move relative to the first element by nesting with the arcuate region 10d, avoiding the need for an arcuate washer pair (as used in the embodiment of FIGS. 2 and 2a). In the arrangement shown in FIG. 4, the depth dimensions of the connection joint 100 are minimised by using a single washer instead of a washer pair. In the particular embodiment shown, the arcuate region 10d surrounding the opening 11 of the first element/headrest plate 10 is substantially concave and the adjacent washer 30b comprises a substantially convex surface to nest with the concave region. The opening 11 is in the form of a slot, allowing the attachment shaft 40 to be slid along the opening/slot 11 for further adjustment of the headrest. However, in other forms, the arcuate region of the first element may be substantially convex and the adjacent nesting washer may comprise a substantially concave surface. As described above in relation to the embodiments of FIGS. 2 to 3d, the arrangement of FIG. 4 comprises a clamping system to clamp/lock and unclamp/unlock the connection joint 100.

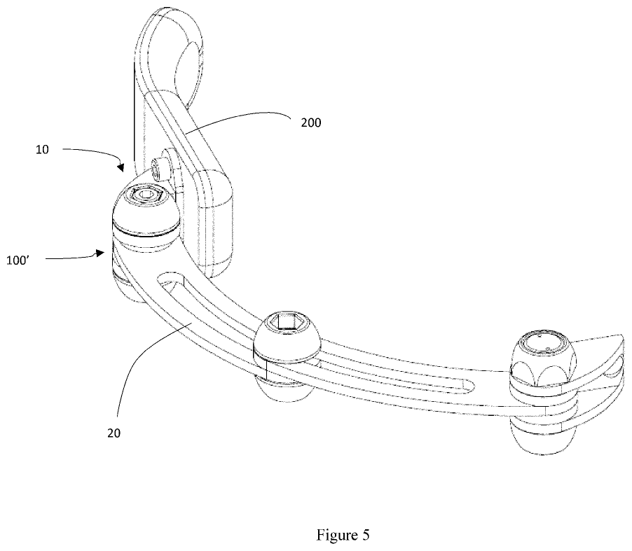

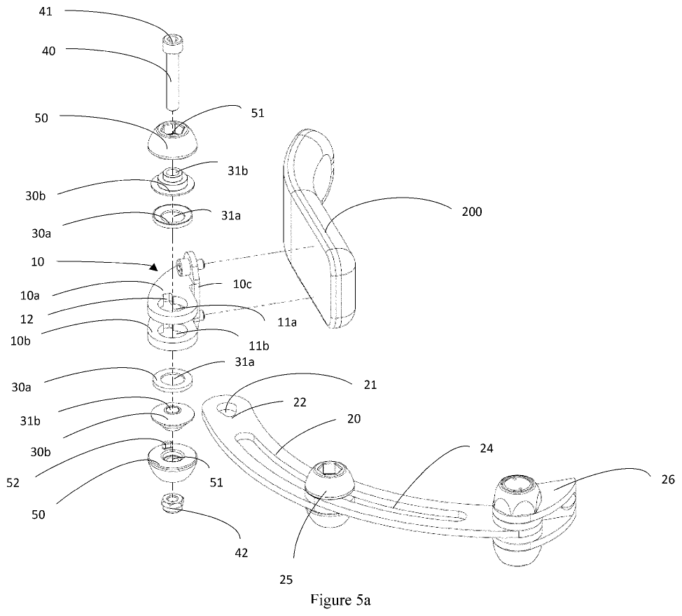

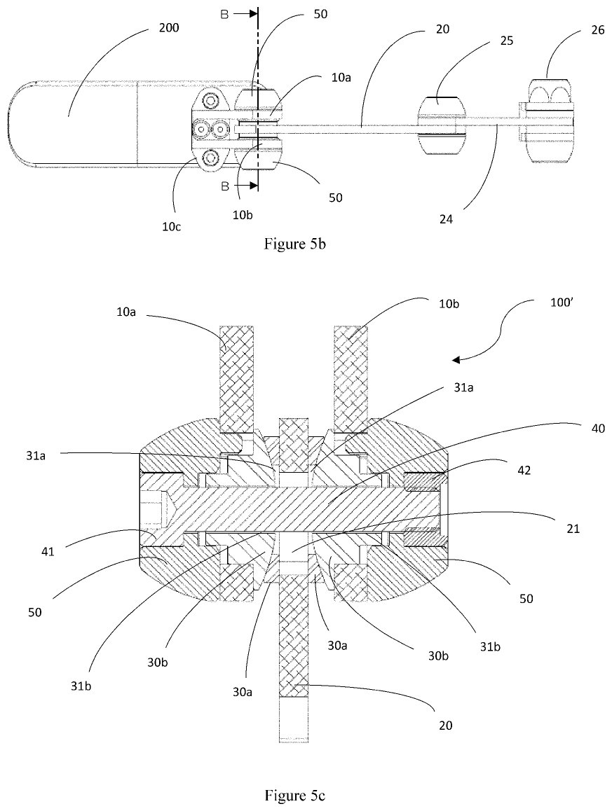

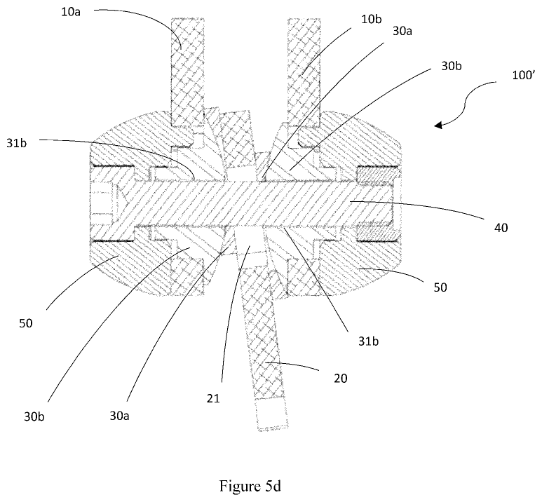

In another alternative form, as shown in FIGS. 5 to 5d, the connection joint 100′ may comprise two or more nesting washer/spacer pairs 30a, 30b and one or both of the first and second elements 10, 20 may comprise two or more arms, each arm comprising an opening for receiving the attachment shaft 40 therein.

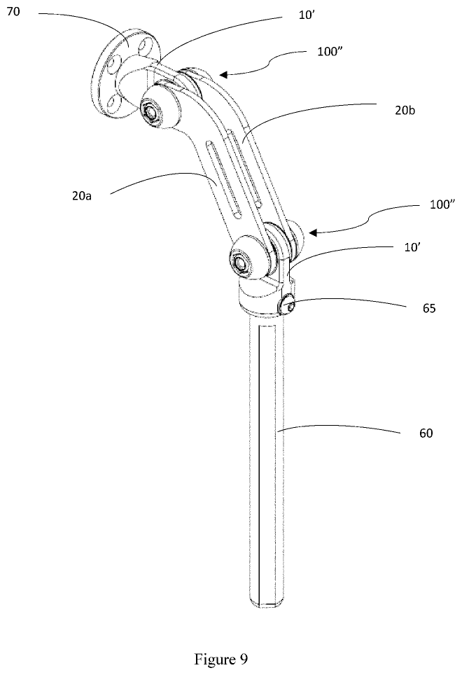

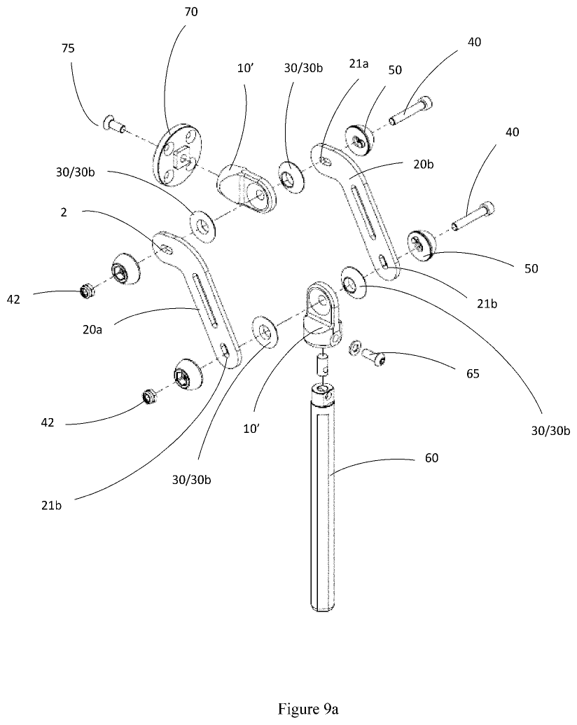

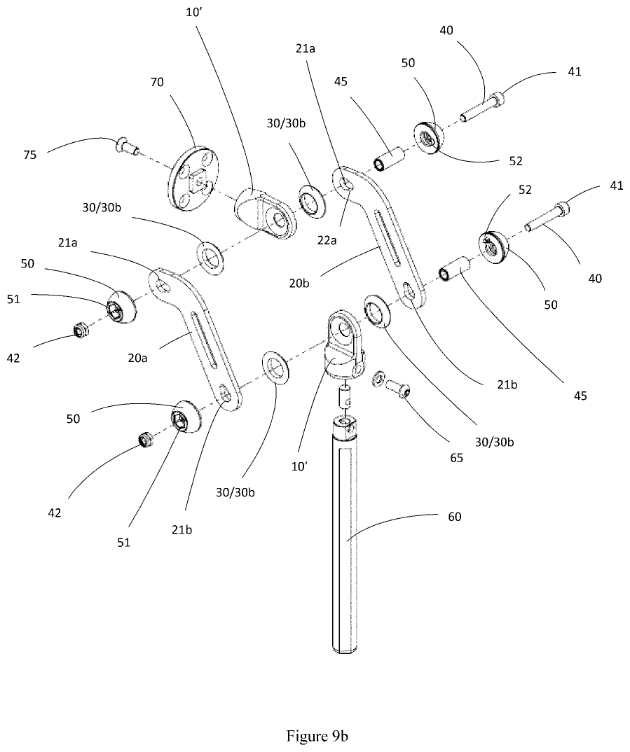

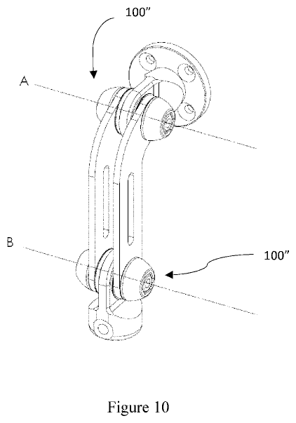

In yet another form, as shown in FIGS. 9 to 12a, the connection joint 100″ may comprise a connector comprising at least one integrated nesting feature so that the connector is configured to take the place of at least one washer/spacer in the connection joint. In some forms, the connector 10′ may comprise two substantially opposing integrated nesting features so that the connector takes the place of two washers/spacers, such that the connection joint may comprise at least two separate nesting washers, but not necessarily any separate nesting washer/spacer pairs.

Turning first to the embodiment shown in FIGS. 5 to 5d, the connection joint 100′ may comprise a first element/support member 10, a second element/connection member 20, and two nesting washer/spacer pairs. Each nesting washer pair comprises a concave nesting washer 30a and a convex nesting washer 30b, as described above. The first element 10 comprises a pair of forked arms 10a, 10b. Each arm 10a, 10b is joined together at a base 10c. The second element 20 is located between the arms 10a, 10b of the first element 10. One of the washer pairs 30a, 30b is located between each arm 10a, 10b and the second element 20, as seen best in FIGS. 5c and 5d. Each arm 10a, 10b of the first element 10, the second element 20, and each nesting washer 30a, 30b comprises an opening 11, 21, 31a, 31b for receiving an attachment shaft 40 therein, as shown in FIG. 5a.

In the embodiment illustrated in FIGS. 5 to 5d, the second element 20 is an elongate member and the opening 21 of the second element 20 is located at one end of the second element so that the length of the second element 20 can pivot about that end. The attachment shaft 40 extends through the openings 11, 21, 31a, 31b in the first and second elements 10, 20 and each pair of nesting washers 30a, 30b such that these components 10, 20, 30a, 30b are slidably located along a portion of the length of the shaft 40. The longitudinal axis of the attachment shaft 40 defines a first axis that extends substantially centrally along the length of the shaft, and about which the components 10, 20, 30a, 30b located along the shaft can rotate when in the unclamped/unlocked position.

Also as shown in FIGS. 5 to 5d, at least one washer in each washer pair 30a, 30b may comprise an enlarged opening/bore 31a, 31b having a diameter greater than that of the cylindrical attachment shaft 40 to provide a sloppy fit with the shaft 40. Optionally, either the first element 10 or the second element 20 may also, or alternatively, comprise an enlarged opening 11, 21 to adopt a sloppy fit with the attachment shaft 40. In some forms, both the first and second elements 10, 20 may comprise an enlarged opening to adopt a sloppy fit with the attachment shaft 40, but a lack of rigidity in the connection joint makes this embodiment ineffective for many uses.

Each of the components of the joint (such as the first element 10 and/or second element 20 and washers 30a and/or 30b) that comprise enlarged openings 11, 21, 31a, 31b are able to rotate, slide and tilt relative to the attachment shaft 40 to adopt a variety of different positions. In other words, these components are rotatable about the first, second and third axes, the second and third axes being substantially perpendicular to the first axis and to each other.

In the connection joint 100′ shown in FIGS. 5 to 5d, the second element 20 and the concave washers 30a each comprise enlarged openings 21, 31a for a sloppy fit with the shaft 40. The arms 10a, 10b of the first element and the convex washers 30b each comprise openings 11a, 11b, 31b dimensioned to snugly and slidably receive the attachment shaft 40 therein, offering some rigidity to the connection joint 100. The enlarged openings 31a of the concave washers 30a allow each concave washer 30a to arcuately slide and rotate across the convex region of the respective nested convex washer 30b in each washer pair. In the embodiment shown, the concave washers 30a are located adjacent the second element 20, so that the opposing, non-nesting rear surface of each concave washer 30a abuts the second element 20. Therefore, as the concave washers 30a arcuately slide and rotate relative to the nested convex washers 30b, the rear surface of each concave washer 30a tilts relative to the attachment shaft 40, pressing against the adjacent second element 20 and causing the second element 20, located between the washers 30a, to tilt accordingly.

Of course, the arrangement may be reversed without departing from the invention. For example, the convex washers 30b may be located adjacent to the second element 20 and the convex washers 30b and the second element 20 may each comprise enlarged openings 31b, 21 to allow a sloppy fit with the attachment shaft 40, such that the convex washers 30b and second element 20 can tilt relative to the attachment shaft 40 and/or the first element 10, as described above in relation to the concave washers 30b and connection member 20. The first element 10 and the concave washers in each washer pair 30a, 30b may comprise an opening 11, 31a, 31b configured to provide a snug and slidable fit with the attachment shaft 40.

In yet another form, a concave washer 30a may be located adjacent one side of the second element 20 and a convex washer 30b may be located adjacent the other side of the second element 20 and each of these concave and convex washers 30a, 30b and the second element 20 may comprise enlarged openings 31a, 31b, 21 for a sloppy fit with the attachment shaft 40 to allow the second element 20 to tilt relative to the attachment shaft 40 and/or the first element 10, as described above. The first element 10 and the other washers in each washer pair 30a, 30b may comprise an opening 11, 31a, 31b configured to provide a snug and slidable fit with the attachment shaft 40.

Optionally, the second element 20 comprises a linking member/linking arm that is able to rotate about the attachment shaft 40 and therefore about the first axis. However, by providing a sloppy fit between the second element 20 and the shaft 40 and between the concave washers 30a and the shaft 40, as shown in FIGS. 5 to 5d, the second element 20 is also able to rotate, to some extent, about a second axis and a third axis, each of the second and third axes being perpendicular to the first axis and to each other to provide the second element 20 with six degrees of freedom.

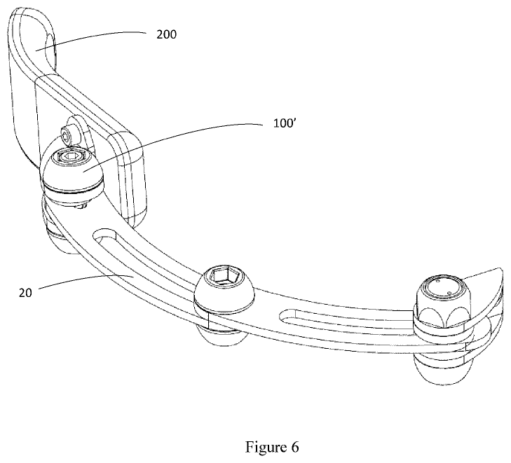

In yet another form, as shown in FIG. 6, each arm 10a, 10b of the first element 10 comprises an enlarged opening and has a sloppy fit with the attachment shaft 40 passing therethrough. Adjacent nesting washers to the arms 10a, 10b of the first element also comprise enlarged openings to have a sloppy fit with the attachment shaft 40 passing therethrough. The second element 20 and the nesting washers 30a, or 30b adjacent the second element 20 each comprise an opening configured to provide a snug and slidable fit with the attachment shaft 40 passing therethrough. In this arrangement, the first element 10 is able to rotate and tilt relative to the attachment shaft 40 by rotating about the first axis, and about second and third axes that are perpendicular to the first axis and to each other to provide the first element 10 with six degrees of freedom.

The connection joint 100′ also comprises a clamping system to clamp the components 10, 20, 30a, 30b of the joint 100′ together in a locked position, and to unclamp the components in an unlocked position in which the first element 10 or the second element 20 (as the case may be) is moveable about the first, second, and third axes.

As shown in FIGS. 5 to 6, a clamping member 41, 42 is provided on either side of the arranged components 10, 20, 30a, 30b at or near the distal ends of the attachment shaft 40. At least one of the clamping members 41, 42 is moveable along the shaft 40 toward or away from the components 10, 20, 30a, 30b to clamp the components together in a clamped/locked position, and to release the components to allow at least one of the first and second elements 10, 20 to move relative to the other in order to be manipulated to a desired position.

As described above, in one form, as shown in FIG. 5a, the attachment shaft 40 may comprise a bolt comprising a threaded portion and an enlarged head 41 that forms one clamping member at one end of the shaft 40. A removable fastener, such as a nut 42 or a T-nut, may be attached to the distal end of the shaft 40 and may form the other clamping member. The first and second elements 10, 20 and washers 30a, 30b are located between the clamping members 41, 42. In this form, only the nut 42 is moveable toward and away the components arranged on the shaft 40.

Alternatively, the attachment shaft 40 may comprise a cylindrical, threaded shaft comprising a nut 41, 42 at each end of the shaft 40, each nut being moveable along the length of the shaft to move between a clamped position and an unclamped position.

For example, by rotating at least one nut 42 or the shaft 40 in a first direction, the nut 42 is caused to move along the shaft 40 toward the other end of the shaft, and presses against the closest one of the components 10, 20, 30a, 30b of the joint that are located between the clamping members 41, 42. As the clamping members press firmly against the components 10, 20, 30a, 30b, the first and second elements 10, 20, and washers 30a, 30b are clamped together in a clamped/locked position. In this position, the first and second elements 10, 20, and washers 30a, 30b are unable to move relative to each other, therefore locking the position of the first part relative to the second part. For example, where the connection joint is used to attach a headrest (a first part) to a wheelchair backrest (a second part), the connection joint will lock the headrest in position relative to the backrest when in the clamped/locked position.

To reach the unclamped position, at least one of the clamping members 41, 42 is caused to move away from the components 10, 20 30a, 30b of the connection joint, such as by moving away from the other clamping element at or near the other end of the shaft 40, in order to release the clamping pressure against the components 10, 20 30a, 30b and adopt an unclamped position. For example, by rotating at least one nut 42 or the shaft 40 in a second direction (opposite to the first direction), the nut 42 is caused to move along the shaft 40 in a direction away from the other end of the shaft, so that the nut 42 releases the clamping pressure on the components 10, 20, 30a, 30b located between the clamping members.

In the unclamped position, at least the first element 10, the second element 20, or both, can tilt relative to the attachment shaft.

Optionally, the connection joint 100′ also comprises a pair of anti-rotation caps 50, in which one of the caps 50 is located at or near each end of the attachment shaft 40. Each cap 50 comprises an opening, such as a recess 51, within which an adjacent clamping member 41, 42, such as the head 41 of an attachment shaft 40 in the form of a bolt, or a nut 42, may be snugly received. Preferably, the bolt head 41 or nut 42 is configured to key or mate with the opening/recess 51 in the respective cap 50. The opening/recess 51 is in communication with an opening that passes through the centre of the cap 50 for receiving a portion of the attachment shaft 40 therein. Therefore, in some forms as shown in FIGS. 5 to 5d, the connection joint 100′ comprises (from one end of the shaft 40 to the other) in order: a first clamping member 41 received within a first anti-rotation cap 50a, a first arm 10a of the first element 10, a first pair of nesting washers 30b, 30a; a second element 20, a second pair of nesting washers 30a, 30b; a second arm 10b of the first element 10, a second clamping member 42 received within a second anti-rotation cap 50b, and an attachment shaft 40 extending through openings of all of these components 50a, 10, 30b, 30a, 20, 30a, 30b, 10b, and 50b.

Each anti-rotation cap 50 is configured to hold the shaft 40 in place while the respective nut 42 is tightened.

In the embodiment of FIGS. 5 to 5d, each cap 50 comprises a projection 52 that engages with a receiving element 12, such as an opening (which may be a hole, recess, or the like) of the first element 10 so that the first element 10 constrains movement of the cap 50, reducing the number of surfaces that are clamped together by friction. In the embodiment of FIG. 5a, the projection 52 comprises a projecting tab and the receiving element 12 comprises a notch formed in the bore 11a, 11b of each arm 10a, 10b of the first element. The tab 52 is snugly received within the respective notch 12 to restrict rotation of the cap 50. This feature is useful to hold the shaft 40 in place while the nut 42 is tightened. Therefore, when the components 10, 20, 30a, 30b are clamped together in a locked position, the tab 52 of each cap is received within the respective notch 12 of the first element 10 and is securely held in position by the clamping members 41, 42. By surrounding the rotatable clamping members, each cap 50 prevents the clamping member therein from inadvertently rotating and unclamping/unlocking the connection joint.

Optionally, the outermost washers 30a, 30b in the arrangement of components (the convex washer 30b in the embodiment shown in FIG. 5a) may comprise an outwardly facing surface that extends through the respective opening of the arms 10a, 10b of the first element and is profiled to engage with an inwardly facing surface of the cap 50, so as to key with the cap. This arrangement may reduce the risk of slippage between the outermost washer and the cap in the clamped/locked position.

The connection joint 100′ may be used to adjustably attach a first part to a second part for many different uses.

In the embodiment shown in FIGS. 5 to 5d, the arms 10a, 10b of the first element 10 attach to a base 10c that forms a mount for the first element, such as a mounting plate. In some forms, the base/mounting plate 10c, as illustrated in FIG. 5b, is attachable to a lateral support 200 for supporting the torso of a person in a chair, such as a wheelchair. The second element 20 may comprise a curved linking member/arm that is slidably attached to a second, curved arm 24 to form an arcuate, jointed connecting arm. The second element 20 may be slidably attached to the second, curved arm 24 via a pivoting attachment joint 25. The second curved arm 24 of the jointed connecting arm may be attached to a bracket 26 that is attachable to the backrest of a chair, such as a wheelchair. Preferably, the bracket is pivotally attachable to the chair.

The connection joint 100′ of the invention is configured to move between a neutral/aligned position and a modified/tilted position in which the first element 10 or the second element 20 (as the case may be) extends at a non-perpendicular angle to the attachment shaft 40.

FIG. 5c shows the connection joint of FIGS. 5a and 5b in a neutral position in which the attachment shaft 40 extends through a substantially central region of the components 10, 20, 30a, 30b, such that the shaft 40 passes through the centre of the opening 11, 21, 31a, 31b of each component. In the neutral position, the first element 10 and the second element 20 each extend along parallel planes that lie substantially perpendicular to the longitudinal axis of the attachment shaft 40.

FIG. 5d shows the connection joint of FIGS. 5a and 5b in the modified, tilted position, in which the second element 20 is tilted relative to the attachment shaft 40 and the arms 10a, 10b of the first element 10. In this modified position one of the nesting washers 30a, 30b in each washer pair has slid and rotated relative to the other nesting washer 30b, 30a in the pair. In the embodiment shown in FIG. 5d, the innermost washers adjacent to the second element 20 (in this case the concave washers 30a) have slid relative to the outermost washers adjacent the arms 10a, 10b of the first element 10 (in this case the convex washers 30b) of each nesting washer pair.

In another form, the invention may comprise a support member/first element/connector 10′ that comprises at least one nesting feature to nest with an adjacent washer in a connection joint of the invention. In some forms, the connector 10′ comprises at least two nesting features to nest with adjacent washers on either side of the connector 10′ within a connection joint. In effect, the connector 10′ is configured to replace what would otherwise have been one or both of the innermost washers from each nesting washer pair 30a, 30b in the arrangements described above.

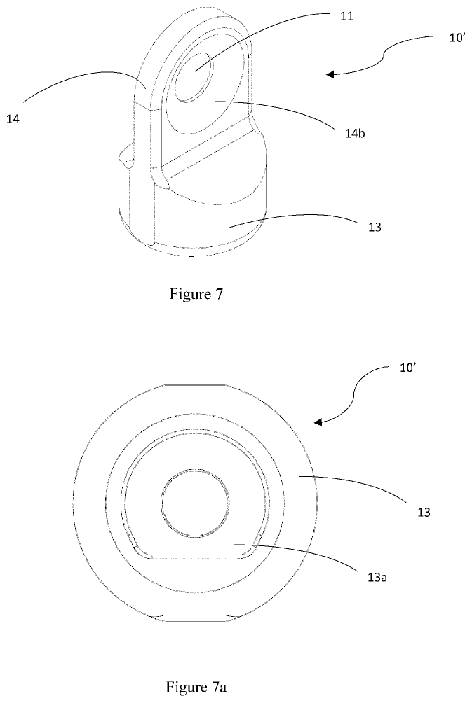

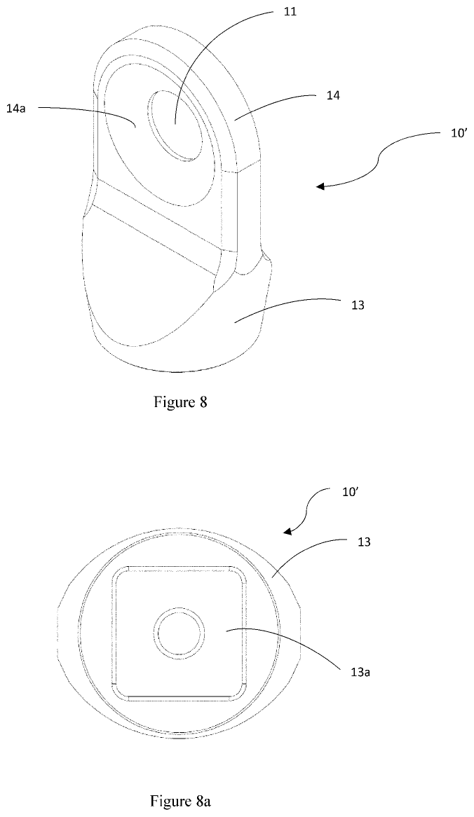

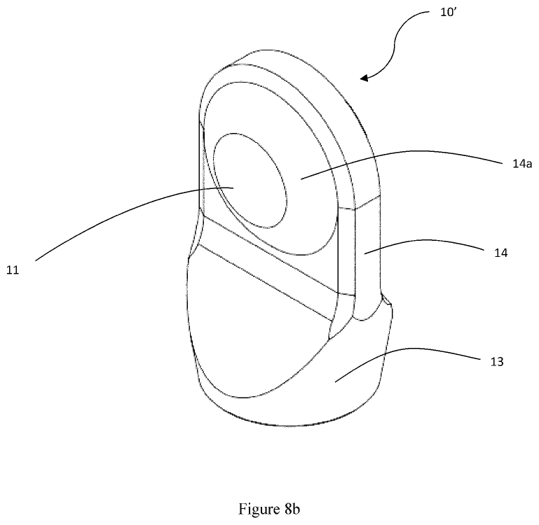

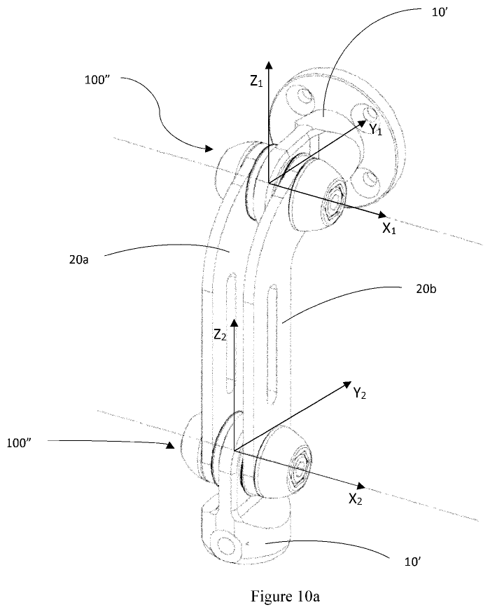

For example, the connection joint 100″ shown in FIGS. 9, 10 and 10a, comprises a connector 10′, as shown in FIGS. 7, 7a, 8 and 8a, that comprises a body comprising a base 13 and a linking element 14 that projects from the base. The shape, dimensions, or configuration of the base 13 of the connector 10′ may differ depending on the surface to which the connector 10′ is to be attached. The linking element 14 comprises opposite side surfaces. Each side surface comprises a nesting feature comprising a semi-spherical curved region 14a, 14b for slidably and rotatably nesting with a complimentary semi-spherical curved region of an adjacent washer. That is to say, washers adjacent each side of the connector 10′ may rotatably and slidably nest with the curved regions of the connector 10′.

In the embodiments shown in FIGS. 7, 7a, 8, and 8a, the nesting features/curved regions 14a, 14b of the connector 10′ are concave and the adjacent nesting washers 30b each comprise a convex nesting region that is slidably and rotatably received within the concave nesting regions of the connector 10′. However, in other forms, as shown in FIG. 8b, the nesting features/curved regions of the connector 10′ may be convex regions and the adjacent nesting washers may each comprise a concave nesting region for receiving a convex nesting region of the connector therein in a slidable and rotatable arrangement. In yet other forms, one side of the connector 10′ may comprise a concave nesting region for nesting with a convex nesting region of an adjacent nesting washer, and the other side of the connector 10′ may comprise a convex nesting region for slidably and rotatably nesting with a concave nesting region of an adjacent nesting washer.

An opening 11, such as a bore or slot, is substantially centrally provided in the curved, nesting regions of the connector 10′. The opening 11 passes through the connector 10′ from one side surface to the other and allows an attachment shaft 40 to be received therein.

In some forms, as shown in FIGS. 7 and 7a, the connector 10′ is configured to be attached to a rod/shaft. In these forms, a bottom surface of the base 13 may comprise an attachment feature, preferably a non-circular attachment feature, such as a projection or a recess, for mating with a complimentary non-circular attachment feature, such as a recess or a projection, provided at a distal end of the rod. For example, as shown in FIG. 7a, the bottom surface of the base 13 may comprise a recess comprising a non-circular opening 13a (in this case the opening is a truncated circle, defined by a curved edge and a flat edge meeting the ends of the curve). The distal end of the rod 60 comprises a complimentary non-circular recess or projection. As shown in FIG. 9a, the distal end of the rod may comprise a truncated circular profile that substantially matches the profile of the recess in the base—in effect, the distal end of the rod 60 comprises a generally cylindrical projection with a flat side wall. The connector 10′ is configured to engage with the rod 60 such that the projecting portion of the rod is received within the recessed portion of the connector base 13. The non-circular profile of the recess and projecting portion of the rod allows the rod 60 to key into the recess 13a so that neither the connector 10′ nor the rod 60 can rotate independently of the other. The arrangement may be reversed so that the base 13 comprises a non-circular projecting attachment feature that engages with a non-circular attachment recess or opening provided at a distal end of the rod 60.

The connector 10′ and rod 60 may be attached by any suitable means. In some forms, a fastener 65, such as a screw, is inserted through a hole formed in the side of the base 13 and through an aligned hole formed in the projecting portion of the rod 60, and engages with an aligned threaded hole in a dowel, which is inserted into a recess in the projecting portion of the rod 60 and recess in the bottom of base 13, so as to attach the connector 10′ and rod 60 together.

In other forms (not shown), the base 13 of the connector 10′ may comprise an attachment feature comprising a threaded region for engaging with a threaded end of the rod 60 in a screw-on/off arrangement, or the base 13 may comprise an attachment feature comprising one or more flanges for abutting a corresponding surface of the rod 60 and by which the connector 10′ can be attached to the rod, such as by inserting screws within openings in the flange(s) and rod 60 or by adhering the flange(s) to the rod 60 or by any other suitable arrangement.

In yet other forms, as shown in FIGS. 8 and 8a, the connector 10′ is configured to be mounted to a substantially flat surface, such as a mounting plate 70. In these forms, the bottom surface of the base 13 may comprise an attachment feature, preferably a non-circular attachment feature, such as a projection or a recess, for keying with a complimentary attachment feature, such as a recess or a projection, on the mounting plate to prevent rotation of the connector 10′ relative to the mounting plate. In the embodiments shown in FIGS. 8, 8a, 9a, and 9b, the base 13 comprises a quadrilateral or square shaped recess for receiving a complimentary quadrilateral or square shaped projection provided on the mounting plate 70. However, any (preferably non-circular) recess and projection may be employed, such as a triangular or hexagonal shape. A hole may be provided within the non-circular attachment feature of the mounting plate 70 for receiving a fastener 75 therein, the fastener also extending into a hole or recess provided in the preferably non-circular attachment feature of the base 13 of the connector 10′. Typically, the fastener 75 is a screw and the hole in the mounting plate and base is a threaded hole for engaging with the screw 75.

Alternatively, the base 13 may be configured to be fastened to the mounting plate 70. In some forms, therefore, the base 13 may comprise one or more openings through which one or more screws or other fasteners may be inserted to attach the connector 10′ to the mounting plate.

The connector 10′ of the invention may therefore be used to replace one of the washers in each washer pair 30, 30b in the connection joint as described above in relation to FIGS. 5 to 5d. In some forms, the connector 10′ replaces two washers, such as where the connector is sandwiched between nesting washers, and therefore allows for a smaller sized connection joint 100 to be provided because the connector 10′, second element 20, and nesting washers 30 (components 10′, 20, 30) take up less space along the length of the attachment shaft. In effect, the connector 10′ removes the need for a pair of nesting washers (each pair comprising a concave washer and a convex washer) to be positioned on each side of the 10′.

As shown in FIGS. 9 to 12a, a connection joint 100″ of the invention may comprise a connector 10′ as shown in FIGS. 7 to 8a.

In some forms, as shown in FIGS. 9 to 12a, two connectors 10′ may be used in two connection joints 100″ that share connection members 20 to form an attachment system according to the invention.

For example, a connection joint 100″ of the invention may comprise a connector/first element/support member 10′ comprising a pair of curved nesting regions 14a, 14b, each nesting feature being located on either side of the linking element/arm 14, as shown in FIGS. 7 to 8a. The connection joint 100″ may also comprise a nesting washer 30 on either side of the centrally located linking element of the connector 10′. Each nesting washer 30 may comprise a complimentary curved region/surface to nest with the adjacent curved nesting region of the connector 10′. A pair of connection members/second elements 20a, 20b may be located on the other side of each nesting washer 30, such that one of the washers 30 is sandwiched between each side surface of the connector 10′ and one of the connection members 20a, 20b. As described above, a central opening/bore 31 is located in each washer 30 for receiving an attachment shaft 40 therein. An opening 21a, 21b is also provided in each of the first and second connection members 20a, 20b for receiving the attachment shaft 40 therein.

In the embodiments shown in FIGS. 9a and 9b, the connector 10′ comprises a concave curved region 14a, 14b on each side of the linking element 14, and a pair of complimentary convex nesting washers 30/30b. One of the convex nesting washers 30/30b is located on either side of the linking element 14 so that the convex region of each washer nests within the respective, adjacent concave region of the connector 10′.

Each of the connection members 20a, 20b shown in FIGS. 9 to 12a comprises a first opening 21a at a first end of connection member. Each connection member 20a, 20b is configured to rotate about its first opening 21a.

In some forms, the connection members 20a, 20b each form a substantially L-shaped or dog-leg shaped link.

An attachment shaft 40 extends through the openings 11, 21a, 31b in the connector 10′, connection members 20a, 20b and the washers 30/30b so that these components 10′, 20a, 20b, and 30/30b are arranged along at least a portion of the length of the attachment shaft 40. The length of the attachment shaft 40 defines a first axis about which the components 10′, 20a, 20b, and 30/30b can rotate.

In some forms, the openings 31 and 21a, 21b of the washers 30 and the connection members 20a, 20b may be enlarged to provide a diameter or width greater than that of the attachment shaft 40 to provide a sloppy fit with the attachment shaft. The opening of the connector 10′ may be configured to provide a snug and slidable fit with the attachment shaft 40.

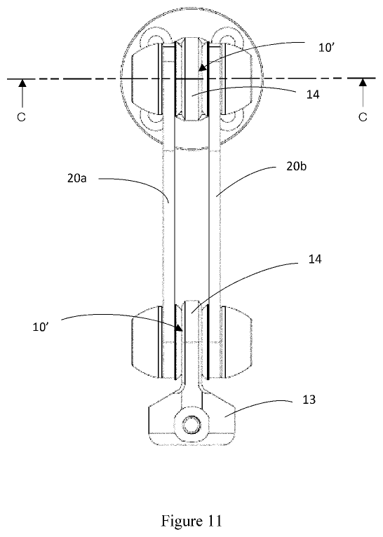

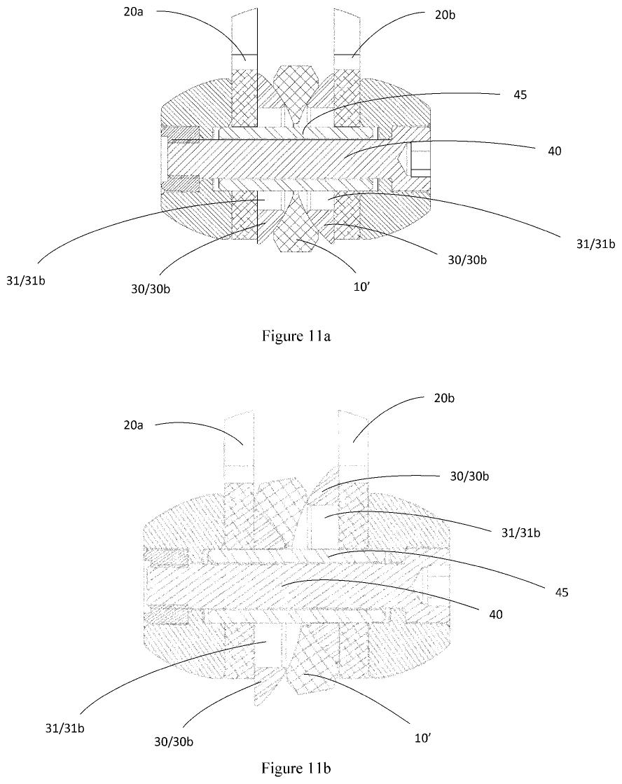

Optionally and as shown, the connection members 20a, 20b are each rotatable about the attachment shaft and therefore about the first axis. However, by providing a sloppy fit between the connection members and the shaft 40 and between the washers 30 and the shaft 40, and by allowing the nesting components to rotatably slide relative to each other, as shown in FIGS. 11a to 11b, the connection members 20a, 20b are able to rotate, to some extent, about a second axis and a third axis, each of the second and third axes being perpendicular to the first axis and to each other to provide the connection members 20a, 20b with six degrees of freedom.

In other forms, the opening 11 of the connector 10′ may be enlarged to provide a diameter or width greater than the diameter of the attachment shaft 40 to provide a sloppy fit with the attachment shaft. The openings of the connecting members 20a, 20b may be configured to provide a snug and slidable fit with the attachment shaft 40. By providing a sloppy fit between the connector 10 and the shaft 40 and between the washers 30 and the shaft 40, and by allowing the nesting components to rotatably slide relative to each other, the connector is able to rotate about a second axis and a third axis, each of the second and third axes being perpendicular to the first axis and to each other to provide the connector 10′ with six degrees of freedom.

The connection joint 100″ may also comprise a clamping system to clamp the components 10′, 20a, 20b, and 30/30b of the joint together in a locked position, and to unclamp the components in an unlocked position in which the connection members 20a, 20b are moveable about the first, second, and third axes.

A clamping member 41, 42 may be provided on either side of the arranged components 10′, 20a, 20b, and 30/30b at or near the distal ends of the attachment shaft 40. At least one of the clamping members is moveable along the shaft 40 toward the components 10′, 20a, 20b, 30/30b to clamp the components together in a clamped/locked position, and is also moveable away from the components 10′, 20a, 20b, 30/30b to release the components to allow at least one of the connector 10′ and the connection members 20a, 20b to move relative to the other in order to be manipulated to a desired position.

In some forms, as shown in FIG. 11a, the attachment shaft 40 may comprise a bolt comprising a threaded portion with an enlarged head 41 that forms one clamping member. A nut 42, such as a T-nut, may be attached to the distal end of the shaft 40 and may form the other clamping member. The connector 10′, connection members 20a, 20b and washers 30/30b are located between the clamping members 41, 42. In this form, only the nut 42 is moveable toward and away the components on the shaft to clamp and unclamp the connection joint.

Alternatively, the attachment shaft 40 may comprise a cylindrical shaft comprising a threaded portion and a removable fastener, such as a nut 41, 42, at each end of the shaft 40, each nut being engageable with and moveable along the length of the shaft to move between a clamped and an unclamped position.

By rotating at least one nut 42, or the shaft, in a first direction, so as to move the nut, or at least one nut, along the shaft 40 toward the other end of the shaft, the nut 42 may be caused to press against the arrangement of components 10′, 20a, 20b, 30/30b located between the clamping members 41, 42 and clamp the components between the 10′, 20a, 20b, 30/30b between the two clamping members 41, 42 in a clamped/locked position.

In the clamped position, the connector 10′, connection members 20a, 20b and washers 30/30b are unable to move relative to each other, therefore locking the position of the first part relative to the second part. For example, where the connection joint is used to attach a headrest to a wheelchair backrest, the connection joint will lock the headrest in position relative to the backrest when in the clamped/locked position.

To reach the unclamped position, at least one of the clamping members 41, 42 is caused to move away from the arrangement of components 10′, 20a, 20b 30/30b, such as by moving away from the other end of the shaft 40, to release the clamping pressure from the components and to adopt an unclamped position. For example, by rotating at least one nut 42, or the shaft, in a second direction (opposite to the first direction), the nut, or at least one of the nuts, is caused to move along the shaft 40 in a direction away from the other end of the shaft, so that the moveable nut 42 releases the clamping pressure on the arrangement of components 10′, 20a, 20b, 30/30b located between the clamping members 41, 42.

In the unclamped position, at least one of the connector 10′ and the connection members 20a, 20b, or both the connector 10′ and the connection members 20a, 20b, can move relative to the other to allow the position of the first part to be adjusted relative to the second part.

Optionally, the connection joint 100″ also comprises a pair of anti-rotation caps 50 in which one of the caps 50 is located at or near each end of the attachment shaft 40. Each cap 50 comprises an opening, such as a recess 51, within which an adjacent clamping member 41, 42, such as the head of an attachment shaft in the form of a bolt 41 or a nut 42, may be snugly received. Preferably, the bolthead 41 or nut 42 is configured to key with the opening 51 in the respective cap 50. The recess 51 is in communication with an opening through the centre of the cap 50 for receiving a portion of the attachment shaft 40 therein. Therefore, the connection joint comprises (from one end of the shaft to the other) in order: a first clamping member 41 received within a first anti-rotation cap 50a, a first connection member 20a, a first curved washer 30 (which is a convex washer 30b in the embodiments shown in FIGS. 9a and 9b); a connector 10′, a second curved washer 30/30b; a second connection member 20b; a second clamping member 42 received within a second anti-rotation cap 50b, and an attachment shaft 40 extending through openings of all of these components 50a, 20a, 30/30b, 10′, 30/30b, 20b, and 50b.

Each anti-rotation cap 50 is configured to engage with the arrangement of components 10′, 20a, 20b, 30/30b so as not to rotate when the connection joint is in the clamped/locked position and to allow for ease of locking and unlocking the connection joint and the attachment system, as described above. In some forms, each cap 50 comprises a projection 52 that engages with a receiving element 22, such as an opening (which may be a hole, recess, or the like) of the adjacent connection member 20a, 20b so that the connection member constrains movement of the cap 50. In the embodiments of FIGS. 9a and 9b, the projection 52 comprises a projecting tab and the opening 22 comprises a notch formed in the opening/bore 21a, 21b of each connection member 20a, 20b. The tab 52 is snugly received within the respective notch 22 so that rotational movement of the shaft is constrained while the nut 42 is tightened or loosened. Therefore, when the components 10′, 20a, 20b and 30/30b are clamped together in a locked position, the tab 52 of each cap 50 is received within the respective notch 22 of the connection members 20a, 20b and is securely held in position by the clamping members 41, 42. By surrounding the rotatable clamping members, each cap 50 prevents the clamping member therein from inadvertently rotating and unclamping/unlocking the connection joint 100″.

In some forms, as shown in FIG. 9b, the connection joint 100″ includes an optional sleeve 45 that surrounds a portion of the attachment shaft 40 and is received within the openings 11, 21a, 21b, and 31/31b of the connector 10′, connection members 20a, 20b, and washers 30/30b and at least a portion of the opening 51 of each cap as shown in FIGS. 9b, 11a, and 11b. The sleeve 45 helps to locate each of the components 10′, 20a, 20b, 30/30b on the attachment shaft 40, such as by substantially aligning the connector, connection members 20a, 20b and washers 30/30b on the attachment shaft 40 to help distribute load along the shaft 40.

The connection joint 100″ of the invention is configured to move between a neutral/aligned position and a modified/tilted position in which the connection members 20a, 20b extend at a non-perpendicular angle to the attachment shaft 40.

In some forms, a first connection joint 100″ comprising a first connector/support member/first element 10′, as described above, may connect with a second connection joint 100″ comprising a second connector/support member/second element 10′, as shown in FIGS. 9 to 12a to form an attachment system. In these arrangements, the connection members 20a, 20b are shared with both the first and second connection joints 100″.

For example, each of the first and second connection members 20a, 20b may comprise a first opening 21a at a first end of the connection member and a second opening 21b at a second end of the connection member. The openings are configured to receive an attachment shaft of the respective first and second connection joints therein. For example, the first opening 21a receives the attachment shaft 40a of the first connection joint and the second opening 21b receives the attachment shaft 40b of the second connection joint. In this way, the connection members 20a, 20b link the first and second connection joints 100″ together. In some forms, each of the connection member openings 21a, 21b are enlarged openings having a width or diameter greater than the diameter of the attachment shaft to provide a sloppy fit between the connection members 20a, 20b and the attachment shaft, whereas the opening 11 of the connector provides a snug and slidable fit with the attachment shaft 40. Each of the nesting washers 30 also comprise an enlarged opening for receiving the attachment shaft 40 therein and for providing a sloppy fit with the attachment shaft.

In other forms, the opening 11 of the connector and the openings of the nesting washers 30 are enlarged to provide a sloppy fit with the attachment shaft 40, and the openings of the connection members 20a, 20b form a snug and slidable fit with the attachment shaft.

Each of the first and second connection joints 100″ may otherwise have the same features and configuration (such as clamping members and optional anti-rotation caps) as described above in relation to the embodiments of FIGS. 9 to 12a.

The attachment system shown in FIGS. 9 to 12a allows for the components of the first connection joint to rotate about a first attachment shaft defining a first axis A and the components of a second connection joint to rotate about a second attachment shaft defining a second axis B, as shown in FIG. 10.

By allowing the connection members 20a, 20b to be mounted on the attachment shafts 40a, 40b of each connection joint 100″ in a sloppy arrangement, the connection members 20a, 20b are not only able to rotate about the first axes x₁, x₂, as shown in FIG. 10a, but the connection members 20a, 20b are also able to rotate to some extent about second axes y₁, y₂ and third axes z₁, z₂ to obtain six degrees of freedom. The second and third axes y₁, y₂, z₁, z₂ of each connection joint 100″ are perpendicular to the first axis x₁, x₂ and to each other, as shown in FIG. 10a.

By allowing the nesting washers 30 to slide and rotate against the curved region of the connector 10′ of each connection joint 100″, the connection members 20a, 20b are able to tilt relative to the connector 10′ or the connector 10′ is able to tilt relative to the connection members 20a, 20b. For example, in FIG. 10, the second connection joint 100″ comprises a first axis passing through line B, and is arranged such that the connection members tilt relative to the connector 10′, which is fixed in position. The first connection joint 100″ comprises a first axis passing through line A, and is arranged such that the connector 10′ tilts relative to the connection members 20a, 20b. This allows each joint 100″ in the attachment system of FIGS. 9 to 12a to move relative to the other such that the position of a first part (to which the first joint is attached) can be moved relative to the position of a second part (to which the second joint is attached), and vice versa.

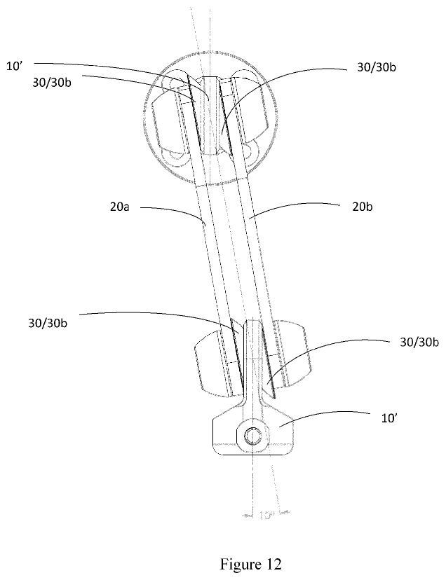

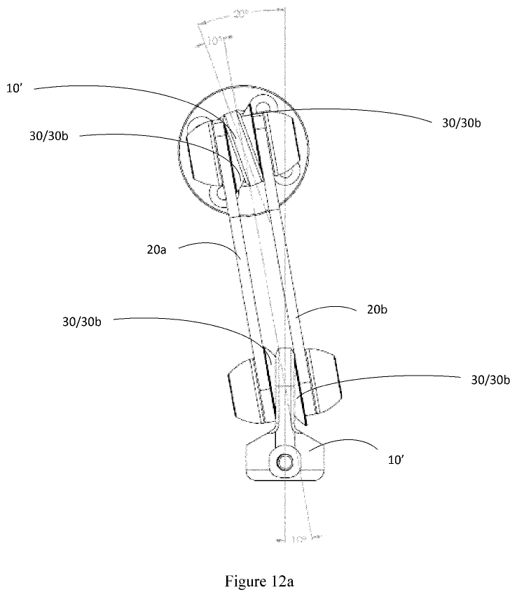

FIG. 12 shows the attachment system of FIGS. 9 to 11b, and in which the connection members 20a, 20b are tilted about 10⁰ from parallel alignment with the connector 10′. FIG. 12a shows the attachment system of FIG. 12 in which the connector 10′ of the first connection joint 100″ (in this case, the upper joint) is tilted about 20° from parallel alignment with the connector of the second connection joint 100″ (in this case, the lower joint) and the connection members 20a, 20b are tilted about 10° from parallel alignment with the connector of the second connection joint 100″ (in this case, the lower joint).

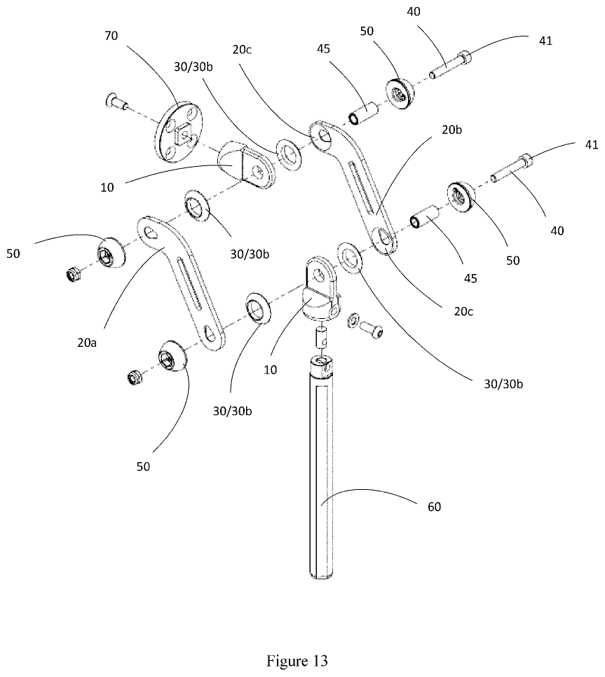

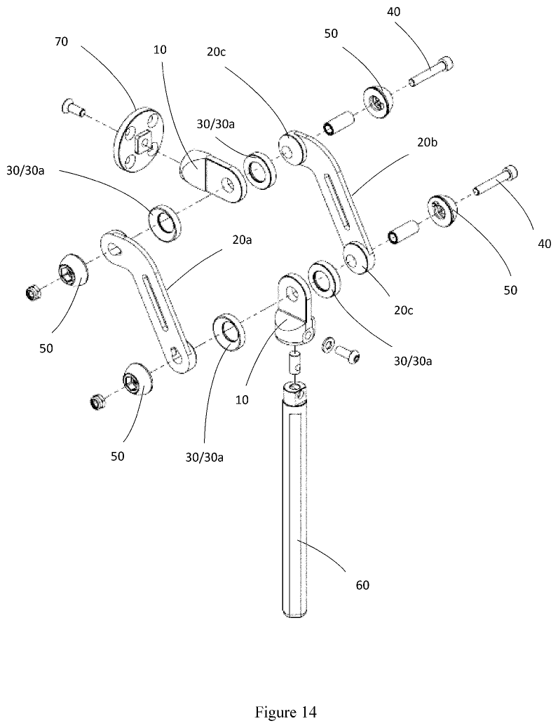

In yet another form, the connection joint 100″ may comprise a pair of connection members 20a, 20b and a connector 10′ located between the connection members. At least one washer may be located between the connector 10′ and each connection member 20a, 20b. Each connection member 20a, 20b may comprise a side surface comprising a curved nesting region 20c facing the adjacent washer 30. The curved nesting region 20c may be a concave region or a convex region. The adjacent washer 30 may comprise a complimentary curved nesting region facing the connection member so that each washer nests with the adjacent connection member. In some forms, one connection member may comprise a concave region and the other may comprise a convex region. In such forms, the adjacent washers have complimentary curved regions to nest with the respective connection member such that the convex region nests within the concave region. The curved nesting washers 30 and connection members 20a, 20b each comprise an enlarged opening 21a, 21b, having a width or diameter greater than that of the attachment shaft 40 passing through openings 11, 21a, 21b, 31 of the connector 10′, connection members 20a, 20b, and washers 30. In this arrangement, the washers and connection members form a sloppy fit with the attachment shaft. The opening 11 of the connector 10′ is only just larger than the diameter of the attachment shaft 40 to form a snug and slidable fit. In this arrangement, the washers 30 are able to rotate about the first axis defined by the attachment shaft 40 and are also able to tilt/rotate about second and third axes that are perpendicular to the first axis and to each other. The connection members 20a, 20b are provided with the same extent of movement, so that the position of the connection members is adjustable relative to the attachment shaft 40, as shown in FIGS. 13 and 14. The arrangement also comprises a clamping system as described above and in relation to the embodiment of FIG. 9a.

In another form, a connection joint of the invention comprises a first part comprising three arms, and four pairs of washers. One arm of the first part is located on each outer side of the outermost washer pairs, and one arm is located between the innermost washer pairs. The joint also comprises a second part that comprises a pair of arms, each arm of the second part being located between a respective one of the outermost washer pairs and one of the innermost washer pairs.

The invention may also be said broadly to consist in the parts, elements and features referred to or indicated in the specification of the application, individually or collectively, in any or all combinations of two or more of said parts, elements or features.

Where, in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the scope of the invention and without diminishing its attendant advantages. It is therefore intended that such changes and modifications be included within the scope of the invention.

1-31. (canceled)

32. A connection joint for attaching a first part to a second part, the joint comprising:
at least one first element;
at least one second element;
at least one first washer between the first and second elements;
an attachment shaft that extends through openings in the first and second elements, and the washer(s) such that the first and second elements and the washer(s) form an arrangement of components;
wherein the attachment shaft defines a first axis substantially centrally located along a length of the attachment shaft, and the first element, the second element, and the washer(s) are rotatable about the first axis;
wherein the at least one first washer comprises a curved region that slidably and rotatably nests with a complimentary curved region of the at least one first element, the at least one second element, or of a second, adjacent washer;
wherein the first element or the second element, or both of the first and second elements, and at least one adjacent washer located between the first and second elements, comprises an enlarged opening comprising a width or diameter greater than a diameter of the attachment shaft to allow the first element, or the second element, or both of the first and second elements to rotate about a second axis and a third axis to adopt various positions relative to the other, the second and third axes being perpendicular to the first axis and to each other; and
wherein the joint further comprises a clamping system that engages with the attachment shaft and comprises a pair of clamping members, at least one of which is moveable toward and away from the other clamping member to clamp the components of the joint together in a locked position, and to unclamp the components in an unlocked position in which the first element or the second element is moveable about the first, second and third axes.

33. The connection joint of claim 32, wherein the first element comprises a pair of arms and the second element is located between the arms of the first element, and
wherein a pair of washers is located between each arm of the first element and the second element, each washer pair comprising a first washer comprising a concave curved region and a second washer comprising a convex curved region for being slidably and rotatably received within the concave region of the first washer;
wherein the opening of each of the first and second washers is substantially centrally located on the washer, and wherein the openings of the first washers or the second washers comprise a diameter larger than a diameter of the attachment shaft.

34. The connection joint of claim 32, wherein the attachment shaft comprises a bolt comprising a threaded portion and at least one clamping member comprises a head of the bolt and the other clamping member comprises a nut located at or near a distal end of the shaft, the nut being moveable toward and away from the bolt head to move between a clamped and unclamped position respectively.

35. The connection joint of claim 34, wherein the joint further comprises a pair of anti-rotation caps, each cap being located proximate to a distal end of the attachment shaft and comprising a recess for receiving the bolt head or nut therein.

36. The connection joint of claim 35, wherein each anti-rotation cap comprises an engagement member for engaging with the first element.

37. The connection joint of claim 32, wherein the second element comprises a first linking arm attached to the attachment shaft, and a second link slidably attached to the first linking arm.

38. The connection joint of claim 32, wherein the first element attaches to a lateral support and the second element attaches to a chair.

39. A connector for connecting a first part to a second part in a connection joint comprising one or more curved washers and an attachment shaft, the connector comprising a body comprising an attachment feature to attach to the first part, and a link element extending from the body,
wherein the link element comprises a pair of substantially opposing surfaces, each surface comprising a curved region adapted to nest with a complimentary curved region of one curved washer of the connection joint, and further comprising an opening located substantially centrally within and passing through each curved region of the link element from one of the substantially opposing surfaces to the other, the opening being adapted to receive the attachment shaft of the connection joint for attaching the second part to the connector.

40. The connector of claim 39, wherein the link element comprises a substantially planar projection that projects substantially centrally from the connector body, and wherein the curved regions are located on opposing sides of the planar projection.

41. A connection joint for attaching a first part to a second part,
the joint comprising:
a first connector as claimed in claim 39,
a pair of connection members,
a pair of washers, each washer being located between the first connector and one of the connection members, and each washer comprising a curved region for slidably and rotatably nesting with the curved region of the first connector;
a first attachment shaft extending through openings of the first connector, the connection members and the washers, the attachment shaft defining a first axis centrally located along its length, wherein the first connector, connection members and washers are rotatable about the first axis, and wherein the connection members, or the washers, or both, each comprise an enlarged opening comprising a diameter greater than a diameter of the attachment shaft such that the connection members, washers, or both, are rotatable about a second axis and a third axis to allow the connection members to adopt various positions relative to the first connector, and wherein the second and third axes are perpendicular to the attachment shaft and to each other; and
a clamping system that clamps together the first connector, the connection members and the washers in a locked position, and that releases the first connector, the connection members and the washers in an unlocked position so that the position of at least the connection members is adjustable relative to the connector.

42. A connection system comprising the connection joint of claim 41 and wherein each connection member comprises a first opening located near a first end of the connection member and through which the first attachment shaft extends, and a second opening located near a second end of the connection member, wherein the first connector is located between the first ends of the connection members and a second connector is located between the second ends of each connection member, and wherein a second washer comprising a curved region for slidably and rotatably nesting with a respective curved region of the second connector is located between the second end of each connection member and the second connector, and wherein the attachment system further comprises:
a second attachment shaft that extends through openings in the second end of each connection member, the second washers, and the second connector; and
a second clamping system that clamps together the second connector, the second ends of the connection members and the second washers in a locked position, and that releases the second connector, the second ends of the connection members and the second washers in an unlocked position so that the position of at least the connection members is adjustable relative to the second connector.

43. A connection joint to adjustably attach a first part to a second part, wherein the joint comprises:
a first washer pair and a second washer pair, wherein each pair comprises a first washer comprising a substantially curved region and a second washer comprising a complimentary curved region, such that each washer in a washer pair slidably and rotatably nests with the other washer in the same washer pair, and wherein the first part is adjacent at least one of the first and second washer pairs and the second part is located between the first and second washer pairs;
an attachment shaft comprising a length that extends through openings provided in the first and second washers of each washer pair and through the first and second parts, wherein the attachment shaft is snugly and slidably received within the opening of the first part and each first washer and wherein the openings of the second washers and the second part have a diameter sufficiently larger than the diameter of the attachment shaft such that the second washers and the second part are tiltable relative to the attachment shaft or the first part and are slidable in a direction substantially perpendicular to the length of the attachment shaft; and
a clamping system to clamp the washers, and first and second parts of the joint together in a locked position, and to unclamp the washers, and first and second parts in an unlocked position in which the second part is moveable about the first, second and third axes.

44. The connection joint of claim 43, wherein the clamping system comprises a clamping member that is moveable along the attachment shaft in a first direction to clamp the first and second washer pairs and the first and second parts together in a locked position, and is moveable along the attachment shaft in a second direction, substantially opposite the first direction, to release the washer pairs and first and second parts such that the position of the first part or the second part is adjustable relative to the other.

45. The connection joint of claim 43, wherein the curved region of the first washer is a convex region and the curved region of the second washer is a concave region, or the curved region of the first washer is a concave region and the curved region of the second washer is a convex region.

46. The connection joint of claim 43, wherein the first part comprises a mounting plate for attaching to a head support or lateral support of a chair, and the second part comprises a brace for attaching a head support or lateral support to a chair.

47. The connection joint of claim 43, wherein the first part comprises a pair of arms, each arm being located on one side of the first and second washer pairs, and wherein the second part is located between the first and second washer pairs.

48. The connection joint of claim 43, wherein a distal end of the attachment shaft, or a clamping member, or both are received within a respective cap that prevents inadvertent rotation and release of the clamping member.

49. The connection joint of claim 43, comprising four pairs of washers, wherein the first part comprises three arms, one arm being located on an outer side of the outermost washer pairs, and one arm being located between the innermost washer pairs, and wherein the second part comprises a pair of arms, each arm of the second part being located between a respective one of the outermost washer pairs and one of the innermost washer pairs.

50. A connection joint for attaching a first part to a second part, the joint comprising:
a first element, a second element and at least one washer between the first and second elements,
wherein each of the first and second elements and the at least one washer comprises an opening;
wherein the connection joint also comprises an attachment shaft that passes through the openings of the first and second elements and the at least one washer and that comprises a length defining a first axis;
wherein the second element comprises a curved region and the at least one washer comprises a complimentary curved region such that the curved region of the washer nests within the curved region of the second element, and
wherein the openings of the washer and the connection joint are larger than a diameter of the attachment shaft to provide a sloppy fit between the washer and the second element, and the attachment shaft, such that at least one of the first and second elements can pivot about the first axis and a second axis and a third axis, the second and third axes being substantially perpendicular to the first axis and to each other.

51. A connection joint for attaching a first part to a second part, the joint comprising a first element, a second element, and a pair of washers located between the first and second elements, wherein one of the washers comprises a concave surface and the other of the washers comprises a convex surface such that the concave and convex surfaces allow the washers to nest together,
wherein an attachment shaft passes through openings provided in the first element, the second element and the washers and defines a first axis about which the first and second elements and the washers can rotate, and wherein the opening of at least one of the washers and of one of the first element and the second element is larger than a diameter of the attachment shaft to provide a sloppy fit between the washer and the first element or the second element, and the shaft, such that at least one of the first element and the second element can pivot about a second axis and a third axis, the second and third axes being substantially perpendicular to the first axis and to each other.
